(19) United States
(12) Patent Application Publication
(10) Pub. No.: US 2021/0090548 A1
(43) Pub. Date: Mar. 25, 2021

(54) TRANSLATION SYSTEM

(71) Applicant: Human, Incorporated, Seattle, WA (US)

(72) Inventors: Joshua Debner, Seattle, WA (US); James Holt, Seattle, WA (US); Piotr Zin, Seattle, WA (US); Zebulun Abalos, Seattle, WA (US); Brian Jackson, Seattle, WA (US)

(21) Appl. No.: 17/045,713

(22) PCT Filed: Apr. 9, 2019
(86) PCT No.: PCT/US19/26632

§ 371 Date: Oct. 6, 2020

Related U.S. Application Data
(60) Provisional application No. 62/654,960, filed on Apr. 9, 2018.

(51) Int. Cl. G10L 13/02; G10L 13/08; G10L 15/00; H04R 1/10

(52) U.S. Cl. CPC G10L 13/02; H04R 1/1008; G10L 15/005; G10L 13/086

(57) ABSTRACT

Systems and methods are directed to a speech translation system and methods for configuring a translation device included in the translation system. The translation device may include a first speaker element and a second speaker element. In some embodiments, the first speaker element may be configured as a personal-listening speaker, and the second speaker element may be configured as a group-listening speaker. The translation device may be configured to selectively and dynamically utilize one or both of the first speaker element and the second speaker element to facilitate translation services in different contexts. As a result, in such embodiments, the translation device may provide a wider range of user experiences that may facilitate translation services.

### BACKGROUND

Currently, some computing systems are configured to provide speech translation services from a spoken language into one or more other spoken languages. For example, a mobile computing device may capture speech of a user, determine that the speech includes the English word “hello,” translate the English word “hello” into the Spanish word “hola,” and playout audio of “hola” via a speaker system. As translation services become more popular and important for commercial and personal interactions, providing a user speaking a first spoken language with the ability to communicate effectively with another user speaking a second spoken language remains an important technical challenge.

### BRIEF DESCRIPTION OF THE DRAWINGS

Embodiments and many of the attendant advantages will become more readily appreciated as the same become better understood by reference to the following detailed description, when taken in conjunction with the accompanying drawings, wherein:

FIG. 1A is a communication system diagram suitable for implementing various embodiments.

FIG. 1B is a component block diagram illustrating a host device illustrated in FIG. 1A, according to some embodiments.

FIG. 2A is a component diagram illustrating a back side of a translation device illustrated in FIG. 1A, according to some embodiments.

FIG. 2B is a component diagram illustrating a front side of a translation device illustrated in FIGS. 1A and 2A, according to some embodiments.

FIGS. 3A-3B are component diagrams illustrating a plurality of translation devices from anterior and posterior sides, according to some embodiments.

FIGS. 4A-4B are pictorial diagrams depicting a translation device operating in a background-listening mode, according to some embodiments.

FIGS. 5A-5B are pictorial diagrams depicting a translation device operating in a personal-listening mode, according to some embodiments.

FIGS. 6A-6B are pictorial diagrams depicting a translation device operating in a foreground-listening mode, according to some embodiments.

FIGS. 7A-7B are pictorial diagrams depicting a translation device operating in a foreground-listening mode, according to some alternative embodiments.

FIGS. 8A-8B are pictorial diagrams depicting a translation device operating in a shared-listening mode, according to some embodiments.

FIGS. 9A-9B are pictorial diagrams depicting a plurality of translation devices operating jointly in a shared-listening mode, according to some embodiments.

FIG. 10 is a flow diagram depicting an illustrative computer-implemented method that may be implemented on, at least, a host computing device to cause a translation device to operate in various modes, according to some embodiments.

FIG. 11 is a flow diagram depicting an illustrative computer-implemented method that may be implemented on, at least, a host computing device to cause a translation device to operate in a foreground-listening mode, according to some embodiments.

FIG. 12 is a flow diagram depicting an illustrative computer-implemented method that may be implemented on, at least, a host computing device to cause a translation device to operate in a shared-listening mode, according to some embodiments.

FIG. 13 is pictorial diagram depicting an example user interface of a host device configured to cause a translation device to operate in various modes, according to some embodiments.

FIG. 14 is a signal and call flow diagram depicting creating a translation group in a translation system, according to some embodiments.

FIGS. 15A-15B are pictorial diagrams depicting an example user interface of a host configured to participate in a translation group, according to some embodiments.

### DETAILED DESCRIPTION

As used herein, the term “speaker” generally refers to an electroacoustic transducer that is configured to convert an electrical signal into audible sound. The term “personal-listening speaker” refers to a speaker that is configured to play out audio at a volume that is suitable for use as a personal listening device. By way of a non-limiting example, a personal-listening speaker may be included in headphone or earphone devices configured to output audio close to a user's ear without damaging the user's hearing. The term “group-listening speaker” refers to a speaker that is configured to output audio at a volume that is suitable for use as a group-listening device. In a non-limiting example, a group-listening speaker may be included in a portable loud speaker, such as a portable Bluetooth® speaker, and may be configured to play out audio having a volume that is audible to a group of individuals close to the group-listening speaker.

Translation devices may include translation services to translate human speech from a first spoken language to a second spoken language. Generally described, a translation service may determine that a speech translation event has occurred (e.g., receiving a user input, sensor measurement, input from another computing device, or some other input). The translation device may obtain audio data that includes human speech in a first spoken language, for example, via a microphone included in the translation device. The translation device may determine the first spoken language of the human speech based on known language detection techniques or a user-selected setting. In some embodiments, the translation device may use one or more known automatic speech recognition (“ASR”) and/or spoken language understanding (“SLU”) techniques in order to generate a textual transcription of the human speech in a second spoken language. The translation device may utilize a dictionary and set of known grammatical rules for a second spoken language to translate the textual transcription of the human speech in the first spoken language into a textual translation of the human speech in the second spoken language. The translation device may then playout the translated human speech in the second spoken language as sound (e.g., via a speaker system included on the translation device).

Some audio systems—such as headphones—include speaker elements that are worn close to users' ears. As a result, these speaker elements may output audio at a comparatively low volume that may enable users wearing such audio systems to enjoy media without disturbing others close by. For users that desire to listen to audio with one or more other users, some audio systems include speaker elements that are configured to output audio at a volume that may be heard by a group of nearby users (e.g., in the same room). However, current audio systems typically are not configured to operate selectively as both a personal-listening system (e.g., headphones) and as a group-listening system (e.g., a public-address system). As a result, a user may need to utilize one audio system for personal listening and a second, separate audio system for group listening.

Similarly, translation devices are limited to outputting translated audio through one audio output at a time. For example, a user may utilize a translation application included in the user's smart phone to record and translate the user's speech; however, the translated speech that the smart phone outputs is only output via the smart phone's internal speakers or through a peripheral device (e.g., a headphone peripheral device). Accordingly, a conventional translation device is unsuitable for playing out translated speech as a personal-listening device and as a group-listening device. For example, a conventional translation device cannot enable a user to have the user's speech translated and playback only for the user's consumption at one moment and then, at another moment, have the user's speech translated and played back for others' consumption.

In overview, aspects of the present disclosure include a speech translation system that features improvements over current translation systems, such as those described above. In various embodiments, a speech translation system may include a translation device. The translation device may include a first speaker element and a second speaker element. In some embodiments, the first speaker element may be configured as a personal-listening speaker, and the second speaker element may be configured as a group-listening speaker. The translation device may be configured to selectively and dynamically utilize one or both of the first speaker element and the second speaker element to facilitate translation services in different contexts, as further described herein. As a result, the translation device may provide a wider range of user experiences that may facilitate personalized translation services and greater user experience.

In some embodiments, the translation device may be configured as a peripheral device that operates in conjunction with a host device. In a non-limiting example, the host device may be a mobile computing device (e.g., a smartphone) that is in communication with the translation device. The translation device may obtain audio data including human speech in a first spoken language via one or more microphones included on the translation device and may provide the audio data to the host device. The host device may perform one or more of speech detection, language detection, and speech translation services in order to generate translated audio data of the human speech in a second spoken language. In some embodiments, the host device may provide the audio data and an indication of a second spoken language to one or more other computing devices (e.g., network computing devices or servers). In such embodiments, the one or more other computing devices may utilize the audio data and indication of a second spoken language to perform one or more of speech detection, language detection, and speech translation services. The host device may receive first translated audio data that includes human speech in a second spoken language from the one or more other computing devices and may provide the translated audio data to the translation device.

The translation device may playout the first translated audio data as sound via at least one of the first speaker and the second speaker. In some embodiments, the host device may determine contextual information associated with the audio data, including but not limited to, a user setting selected by a user of the translation device and/or host device. Based at least in part on this contextual information, the host device may cause the translation device to playout the first translated audio data via the first speaker or the second speaker.

Automatic speech translation typically utilizes automatic speech recognition and/or natural language processing to determining the most likely meaning of human speech included in audio data. As current speech translation techniques sometimes misinterpret the meaning of human speech, such techniques may ultimately mistranslate the human speech, often without the user realizing that the translation is incorrect. Accordingly, in some additional (or alternative) embodiments, the host device may cause the translation device to play out a recognized meaning of the human speech in the user's language, in addition to causing the translation device to play out a translated representation of the human speech in another language. Specifically, the host device may obtain second translated audio data that includes a representation of the speech included in the audio data in a first spoken language. This representation of the speech included in the audio data in a first spoken language may correspond to the meaning attributed to the human speech that the translation device initially captured. In such embodiments, the host device may cause the translation device to output the first translated audio data via the second speaker element and output the second translated audio data via the first speaker element. By way of a non-limiting example, the translation device may capture human speech in English via one or more microphones included in the translation device. The translation device may provide audio data including the captured human speech to the host device. In some embodiments, the host device may determine whether a personal-playback mode has been selected by the user, which indicates that the user desires to hear a representation of the human speech in the first spoken language (e.g., English) in addition to a representation of the human speech in a second spoken language (e.g., Spanish). The host device may (directly or indirectly) determine that the human speech represented in the audio data is English, for example, based on a user setting or via known language detection techniques. The host device may also determine that a desired second spoken language is Spanish, for example, based on another user setting. The host device may obtain (directly or indirectly) first translated audio data including a representation of the human speech in Spanish and may obtain (directly or indirectly) second translated audio data including a representation of the human speech in English. The host device may then provide the first translated audio data and the second audio data to the translation device for play out as sound.

In various embodiments, one or more speech translation services operating on some combination of the first translation device, the host device, and/or another computing device (e.g., the network computing device) may distinguish between sound that includes human speech and sound that does not include human speech, for example, by utilizing one or more speech recognition techniques as would be known by one of skill in the art. For ease of description, the following descriptions may omit references to or details surrounding determining whether sound includes human speech and may instead describe situations in which one or more speech translation services have already determined that obtained sound includes human speech.

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

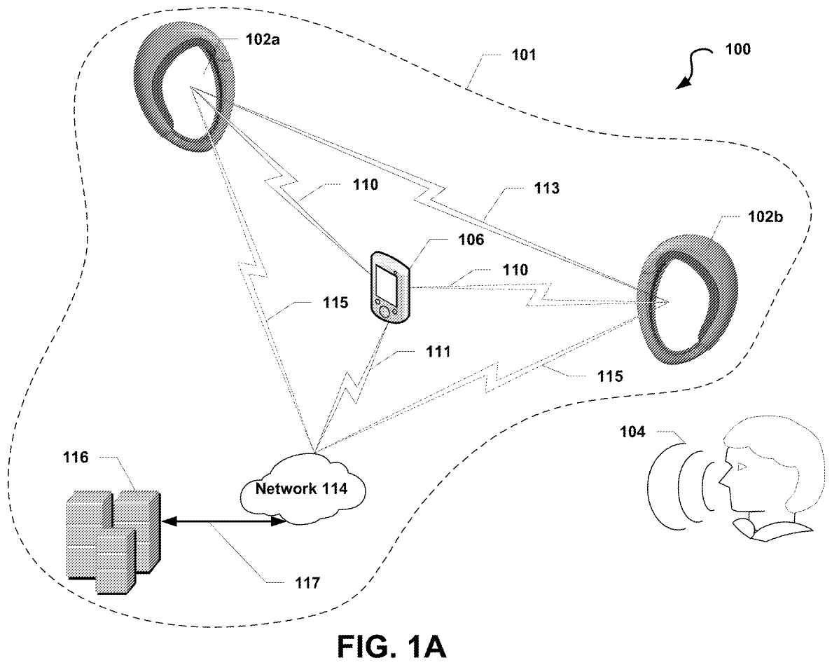

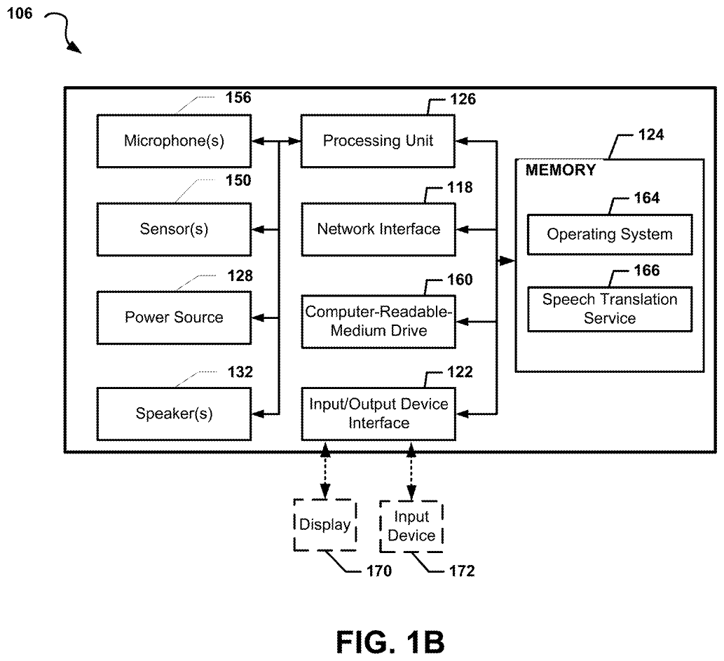

FIG. 1A is a block diagram depicting an illustrative operating environment 100 suitable for implementing aspects of the present disclosure, according to some embodiments. In the example illustrated in FIG. 1A, a speech translation system 101 may include a first translation device 102a. In some optional embodiments, the speech translation system 101 may include one or more other devices, including but not limited to: one or more other translation devices (e.g., a second translation device 102b), one or more host computing devices (e.g., a host computing device 106), and one or more network computing devices (e.g., a network computing device 116). Without limitation, each of the translation devices 102a, 102b, the hosting computing device 106, and the one or more network computing devices 116 may be a personal computing device, laptop computing device, hand held computing device, terminal computing device, mobile device (e.g., mobile phones or tablet computing devices), wearable device configured with network access and program execution capabilities (e.g., “smart eyewear,” “smart watches,” “smart earphones,” or “smart headphones”), wireless device, electronic reader, media player, home entertainment system, gaming console, set-top box, television configured with network access and program execution capabilities (e.g., “smart TVs”), or network servers. In the non-limiting example illustrated in FIG. 1A, the first and second translation devices 102a and 102b are depicted as earphones configured to be worn on a user's ears or shared between two users, the host computing device 106 is depicted as a mobile computing device (e.g., a smart phone), and the one or more network computing device 116 are depicted as network servers. One or more of the devices in the speech translation system 101 may include at least one processor and memory generally configured to implement various embodiments, as further described herein.

In some embodiments, a device included in the speech translation system 101 may be directly or indirectly in communication with one or more other devices included in the speech translation system 101. In the example illustrated in FIG. 1A, the first translation device 102a and the second translation device 102b may communicate directly with each other via a wireless communication link 113, such as a Wi-Fi Direct, Bluetooth®, or similar communication link. In some additional (or alternative) embodiments, the first translation device 102a and the second translation device 102b may communicate with the host computing device 106 via communication links 110, respectively. In some embodiments, at least one of the first translation device 102a, second translation device 102b, and the host computing device 106 may be in direct or indirect communication with one or more network computing devices 116 via at least one network 114. For example, the host computing device 106 may establish a wireless communication link 111 (e.g., a Wi-Fi link, a cellular LTE link, or the like) to a wireless access point, a cellular base station, and/or another intermediary device included in the network 114, which may be directly or indirectly in communication with the one or more network computing devices 116 (e.g., via communication link 117). In another non-limiting example, the first translation device 102a and/or the second translation device 102b may communicate directly or indirectly with the one more network computing devices 116 via one or more communication links 115 to the network 114.

Each of the communication links 110, 111, 113, 115, 117 described herein may be communication paths through networks (not shown), which may include wired networks, wireless networks or combination thereof (e.g., the network 114). In addition, such networks may be personal area networks, local area networks, wide area networks, cable networks, satellite networks, cellular telephone networks, etc. or combination thereof. In addition, the networks may be a personal area network, local area network, wide area network, over-the-air broadcast network (e.g., for radio or television), cable network, satellite network, cellular telephone network, or combination thereof. In some embodiments, the networks may be private or semi-private networks, such as a corporate or university intranets. The networks may also include one or more wireless networks, such as a Global System for Mobile Communications (GSM) network, a Code Division Multiple Access (CDMA) network, a Long Term Evolution (LTE) network, or some other type of wireless network. Protocols and components for communicating via the Internet or any of the other aforementioned types of communication networks are well known to those skilled in the art and, thus, are not described in more detail herein.

In some embodiments, the first translation device 102a and the second translation device 102b may maintain a master-slave relationship in which one of the first translation device 102a or the second translation device 102b (the “master” device) coordinates activities, operations, and/or functions between the translation devices 102a, 102b via the wireless communication link 113. The other translation device of the first translation device 102a or the second translation device 102b (the “slave” device) may receive commands from and may provide information or confirmations to the master device via the communication link 113. By way of a non-limiting example, the first translation device 102a may be the master device and may provide audio data and timing/synchronization information to the second translation device 102b to enable the second translation device 102b to output the audio data in sync with output of the audio data by the first translation device 102a. In this example, the first translation device 102a may provide a data representation of a song and timing information to the second translation device 102b to enable the second translation device 102a and the first translation device 102a to play the song at the same time via one or more of their respective speakers. Alternatively, the first translation device 102a and the second translation device 102b may be peer devices in which each of the devices 102a, 102b shares information, sensor readings, data, and the like and coordinates activities, operations, functions, or the like between the devices 102a, 102b without one device directly controlling the operations of the other device. In some embodiments, the host computing device 106 may be in communication with only one of the first translation device 102a and the second translation device 102b (e.g., a “master” device, as described above), and information or data provided from the base device 103 to the master device may be shared with the other one of the first translation device 102a and the second translation device 102b (e.g., the “slave” device, as described above).

In some embodiments, the first translation device 102a and the second translation device 102b may each include a microphone or another transducer configured to capture sound that includes human speech (e.g., speech 104 as illustrated in FIG. 1A). Generally and as further described (e.g., at least with reference to FIGS. 1B-4B), one or more devices of the speech translation system 101 may be configured to obtain speech captured using the first translation device 102a, convert the speech from a first spoken language associated with the first translation device 102a into a second spoken language associated with the second translation device 102b, and cause a transcription of or audio data including the speech in the second spoken language to be output on the second translation device 102b. Similarly, one or more devices of the speech translation system 101 may be configured to obtain speech captured using the second translation device 102b, convert the speech from the second spoken language to the first spoken language, and cause a transcription or audio of the speech in the first spoken language to be output on the first translation device 102a.

For ease of illustration and description, the speech translation system 101 is illustrated in FIG. 1A as including the first translation device 102a, the second translation device 102b, the host computing device 106, and one or more network computing devices 116. However, in some embodiments, the speech translation system 101 may include more or fewer computing devices than those illustrated in FIG. 1A or may include combinations of such devices. Accordingly, in some embodiments and without limitation, the speech translation system 101 may include two or more translation devices, zero or more host computing devices, and zero or more network computing devices.

FIG. 1B depicts a general architecture of the host device 106 (e.g., as described with reference to FIG. 1A), which includes an arrangement of computer hardware and software components that may be used to implement aspects of the present disclosure, according to some embodiments. The host device 106 may include many more (or fewer) elements than those shown in FIG. 1B. It is not necessary, however, that all of these generally conventional elements be shown in order to provide an enabling disclosure.

As illustrated, the host device 106 may include an input/output device interface 122, a network interface 118, at least one microphone 156, a computer-readable-medium drive 160, a memory 124, a processing unit 126, a power source 128, an optional display 170, and at least one speaker 132, all of which may communicate with one another by way of a communication bus. The network interface 118 may provide connectivity to one or more networks or computing systems, and the processing unit 126 may receive and/or send information and instructions from/to other computing systems or services via the network interface 118. For example (as illustrated in FIG. 1A), the network interface 118 may be configured to communicate, directly or indirectly, with the second translation device 102b, the host computing device 106, and/or the one or more network computing devices 116 via wireless communication links, such as via a Wi-Fi Direct® or Bluetooth® communication links. The network interface 118 may also (or alternatively) be configured to communicate with one or more computing devices via a wired communication link (not shown).

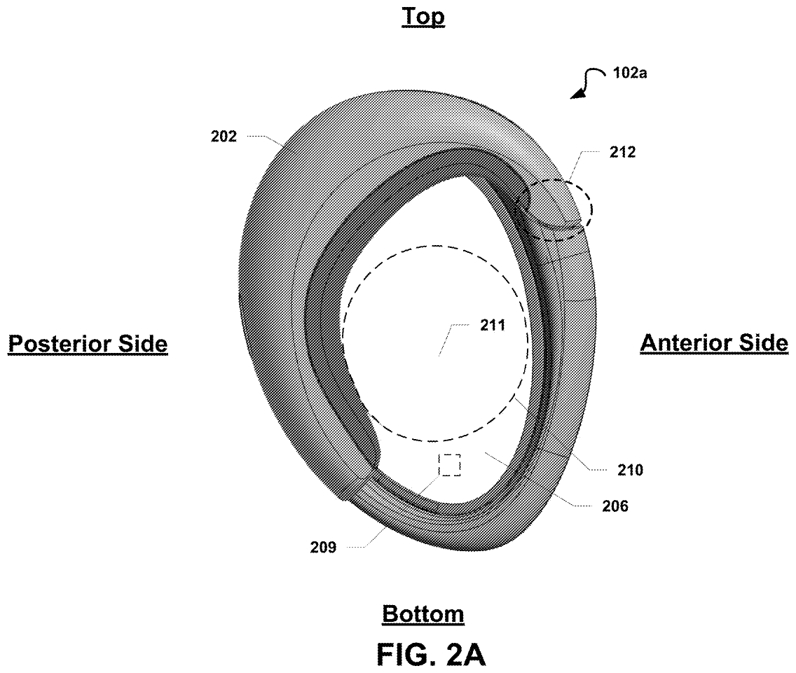

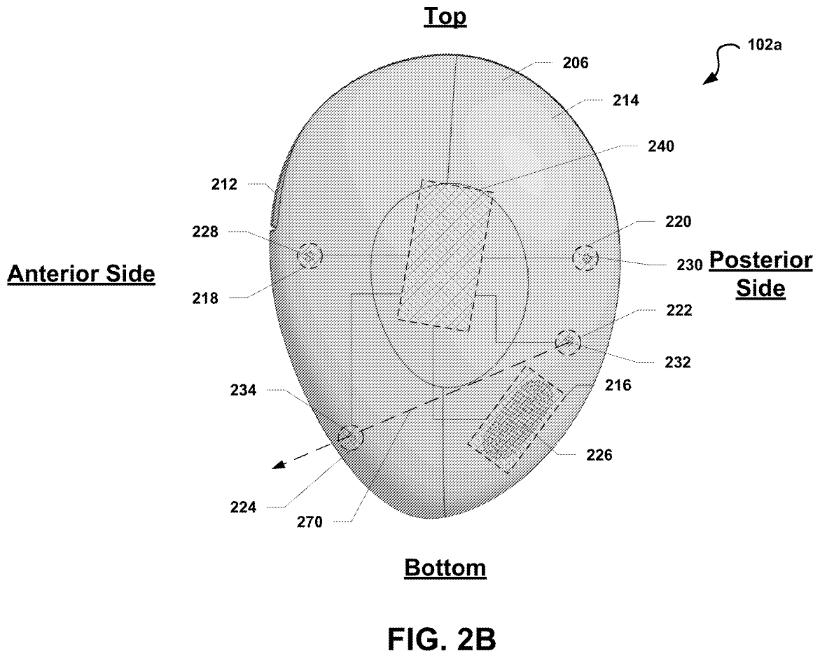

The processing unit 126 may communicate to and from memory 124 and may provide output information for the optional display 170 via the input/output device interface 122. In some embodiments, the memory 124 may include RAM, ROM, and/or other persistent, auxiliary or non-transitory computer-readable media. The memory 124 may store an operating system 164 that provides computer program instructions for use by the processing unit 126 in the general administration and operation of the host device 106. The memory 124 may further include computer program instructions and other information for implementing aspects of the present disclosure. For example, in some embodiments, the memory 124 may include a speech translation service 166, which may be executed by the processing unit 126 to perform various operations, such as those operations described with reference to FIGS. 2A-15B.

In some embodiments, the speech translation service 166 may obtain audio data, for example, from the at least one microphone 156. The speech translation service 166 may determine that the audio data includes human speech, for example, by utilizing one or more speech detection techniques as would be known to one skilled in the art. The speech translation service 166 may also determine that the human speech is associated with a first spoken language (e.g., English, French, or the like) using language detection techniques as would be known to one skilled in the art. The speech translation service 166 may translate the human speech into a second spoken language. The speech translation service 166 may perform one or more operations, such as causing audio data comprising a translation of the speech to be provided to another computing device for playout as sound (e.g., by causing the network interface 118 to transmit the audio data to the second translation device 102b) and/or causing such audio data to be played out as sound on the one or more speakers 132 of the host device 106. In embodiments in which the audio data is provided to an external computing device, the external computing device may provide audio data with the translated human speech to the speech translation service 166 and/or to another computing device at the direction of the speech translation service 166.

While the speech translation service 166 is illustrated as a distinct module in the memory 124, in some embodiments, the speech translation service 166 may be incorporated as a module in the operating system 164 or another application or module, and as such, a separate speech translation service 166 may not be required to implement some embodiments. In some embodiments, the speech translation service 166 may obtain audio that include human speech that has been translated from another computing device (e.g., from another translation device operating on the second translation device 102a). In response, the speech translation service 166 may cause the audio data to be played out via the at least one speaker 132 or, optionally, via one or more other speakers (e.g., either on the host device 106 or on another computing device).

In some embodiments, the input/output interface 122 may also receive input from an optional input device 172, such as a keyboard, mouse, digital pen, microphone, touch screen, touch pad, gesture recognition system, voice recognition system, image recognition through an imaging device (which may capture eye, hand, head, body tracking data and/or placement), gamepad, accelerometer, gyroscope, or another input device known in the art. In some embodiments, the microphone 156 may be configured to receive sound from an analog sound source. For example, the microphone 156 may be configured to receive human speech (e.g., the speech 104 described with reference to FIG. 1A). The microphone 156 may further be configured to convert the sound into audio data or electrical audio signals that are directly or indirectly provided to the speech translation service 166, as described. In some embodiments, the at least one microphone 156 may be a directional microphone or, alternatively, an omnidirectional microphone. In some embodiments, the host device 106 may be in communication with one or more displays, such as the display 170, and the speech translation service 166 may cause a translated transcription of speech to be displayed on the display 170.

In some embodiments, the host device 106 may include one or more sensors 150. The one or more sensors 150 may include, but are not limited to, one or more touch sensors (e.g., capacitive touch sensors), biometric sensors, heat sensors, chronological/timing sensors, geolocation sensors, gyroscopic sensors, accelerometers, pressure sensors, force sensors, light sensors, or the like. In such embodiment, the one or more sensors 150 may be configured to obtain sensor information from a user of the host device 106 and/or from an environment in which the host device 106 is utilized by the user. The processing unit 126 may receive sensor readings from the one or more sensors 150 and may generate one or more outputs based on these sensor readings. For example, the processing unit 126 may configure a light-emitting diode included on the audio system (not shown) to flash according to a preconfigured patterned based on the sensor readings.

In some embodiments, one or more of the first translation device 102a, the second translation device 102b, and/or the one or more network computing devices 116 may be configured similarly to the host device 106 and, as such, may be configured to include components similar to or the same as one or more of the structural or functional components described above with reference to the host device 106. Accordingly, while the speech translation service 166 of the host device 106 is described herein as performing one or more operations in various embodiments described herein, such operations may be performed by a speech translation service operating on one or more similarly computing devices (individually or collectively) included on one or more devices in the speech translation system 101. As such, unless explicitly limited in the claims, descriptions of operations performed by the host device 106 are not limited to being performed only by a translation device and may be performed by one or more computing devices in the speech translation system 101.

FIGS. 2A-2B illustrate exterior views of the translation device 102a (e.g., as described above with reference to FIGS. 1A-1B), according to some embodiments. FIG. 2A illustrates an exterior view of a back side of the translation device 102a. FIG. 2B illustrates an exterior view of a front side of the translation device 102a. With reference to the examples illustrated in FIGS. 2A-2B, the translation device 102a may include a plurality of structural features, including without limitation, an attachment body 202 and a device body 206. In some embodiments, the attachment body 202 may be coupled to the device body 206 via a hinge 212. The hinge 212 may be configured to enable the device body 206 to be moved (e.g., swung, rotated, or pivoted) away from the attachment body 202 to cause the translation device 102a, for example, to transition from a closed configuration (e.g., as illustrated in FIG. 2A) to an open configuration by rotating about a rotational axis (not shown). The hinge 212 may also be configured to enable the device body 206 to be moved (e.g., swung, rotated, or pivoted) back towards the attachment body 202, for example, to transition the translation device 102a from an open configuration to a closed configuration by rotating in the opposite direction along the rotational axis.

In some embodiments (not shown), the translation device 102a may be suitable for receiving at least a portion of a user's ear in a space formed between the attachment body 202 and the device body 206. The translation device 102a may be secured to the user's ear by securing at least the portion of the user's ear between the attachment body 202 and the device body 206.

In some embodiments, the device body 206 may include or be coupled to a first speaker system 210. The first speaker system 210 may be obscured by (e.g., covered by) an ear pad 211 that engages a user's ear when the first translation device 102a is worn by the user. In some embodiments, the first speaker system 210 may be configured to produce sound that is directed through the ear pad 211. In such embodiments, the ear pad 211 may include or may be made from one or more acoustically transparent materials, such as acoustically transparent foam. An acoustically transparent material is a material that enables sound (or certain frequencies) of sound to pass without attenuating the sound or by only slightly attenuating the sound. Thus, in such embodiments, the first speaker system 210 may produce sounds towards the ear pad 211, and the sound may pass without attenuation (or only slightly attenuated) towards the ear canal of the user's ear.

In some embodiments (e.g., as illustrated in at least FIG. 2B), the device body 206 may include a touch plate 214. The touch plate 214 may be made from one or more materials or a combination of one or more materials, such as one or more types of plastic. In some embodiments, the device body 206 may include a touch-sensitive sensor or sensors (not shown) under the touch plate 214. By way of a non-limiting example, the touch sensitive sensor or sensors may be a capacitive touch sensor or one or more other touch sensitive sensors known in the art. In such embodiments, the touch plate 214 may be made from a material suitable for enable the touch-sensitive sensor or sensors to measure changes in electrical properties, such as when a user's finger touches the touch plate 214.

In some embodiments, the device body 206 may include one or more electronic components, such as a processing unit 240, a first microphone 209 (e.g., as depicted in the example illustrated in FIG. 2A), a second microphone 218, a third microphone 222, a fourth microphone 224, a lighting element 220, and a second speaker system 216. In such embodiments, the processing unit 240 may receive power from at least one electrical lead that supplies power from a power source (not shown). The processing unit 240 may also be in electrical communication with the microphones 209, 218, 222, 224, the lighting element 220, the first speaker system 210 (e.g., as depicted in FIG. 2A), and the second speaker system 216. The processing unit 240 may receive input from one or more of the above electrical components and may send signals to one or more of the above electrical components to control, change, activate, or deactivate operations of one or more of the above electrical components. In some embodiments, the processing unit 240 may include or a digital signal processor or another processor that may be configured to receive and process audio signal inputs from one or more of the microphones 209, 218, 222, 224. The processing unit 240 may also be configured to provide audio signals to one or both of the speaker systems 210, 216 to cause those speaker systems 210, 216 to output the audio signals as sound.

In some embodiments, the first microphone 209 may be included or embedded in the device body 206 near the first speaker system 210 and may be configured to capture sound from the first speaker system 210. The first microphone 209 may provide audio signals of the sound captured from the first speaker system 210 to the processing unit 240. The processing unit 240 may utilize those audio signals to perform one or more known active-noise-cancelling techniques. In some embodiments, the first microphone 209 may be positioned underneath or may be obscured by the ear pad 211 (e.g., as illustrated in FIG. 2A). In some additional or alternative embodiments, the processing unit 240 may utilize audio signals generated by one or more of the other microphones 218, 222, 224 to perform active noise cancellation. For example, the processing unit 240 may receive audio signals representative of ambient sound from one or more of the microphones 218, 222, 224 and may utilize these audio signals to modify audio signals provided to one or both of the speaker systems 210, 216, for example, to cancel the ambient noise by generating 180-degrees-out-of-phase anti-noise signals as would be known by one skilled in the arts.

In some embodiments, the touch plate 214 may be configured to include a first microphone port 228, a second microphone port 232, and a third microphone port 234. Each of the ports 228, 232, 234 may be formed as one or more openings in the touch plate 214 that may permit ambient sound to pass through the openings and to be captured by the second, third, and fourth microphones 218, 222, 224, respectively. In some embodiments, at least two of the microphones 218, 222, 224 and their respective ports 228, 232, 234 may be positioned along an axis so that the processing unit 240 may utilize audio signals generated from those at least two microphones to perform beamforming and/or noise-cancellation techniques. For example (e.g., as illustrated in FIG. 2B), the microphones 224 and 222 may be positioned along an axis (e.g., as represented by the dotted, arrow line 270) that extends towards a user's mouth while the user is wearing the ear-worn device. In this example, the processing unit 240 may receive audio signals from at least these two microphones 224 and 222 and may perform beamforming/noise-cancellation to improve the quality of a user's voice that is captured by those microphones. In some embodiments, the touch plate 214 may include a speaker port 226. The speaker port 226 may include one or more openings that are suitable for enabling sound generated from the second speaker system 216 to pass through the speaker port 226 into the surroundings.

The lighting element 220 may be one of various types of lighting devices, such as a light-emitting diode. In some embodiments, the processing unit 240 may control various characteristics of the lighting element 220, including activating/deactivating the lighting element 220, causing the lighting element 220 to display one or more colors or combinations of colors, and the like. In some embodiments, the touch plate 214 may include a lighting port 230 including one or more openings that are suitable for enabling light generated from the lighting element 220 to pass through.

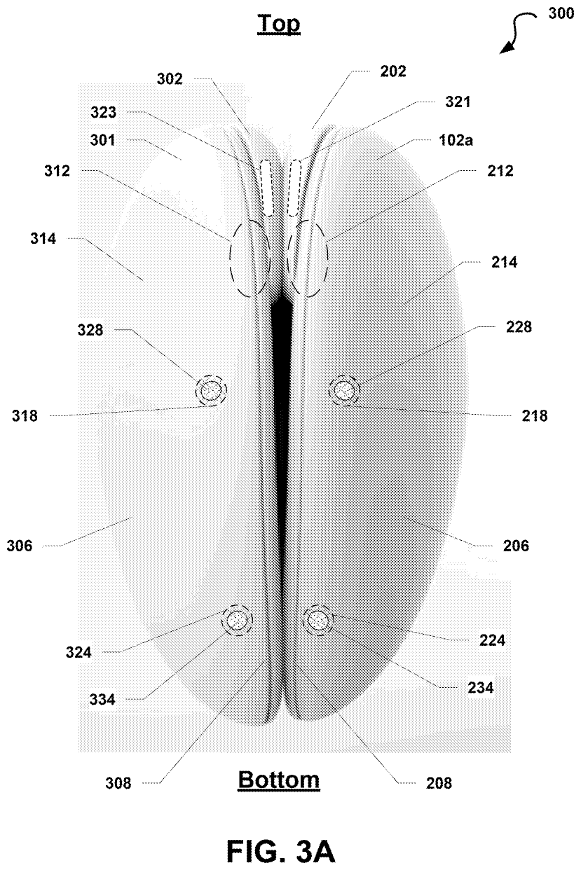

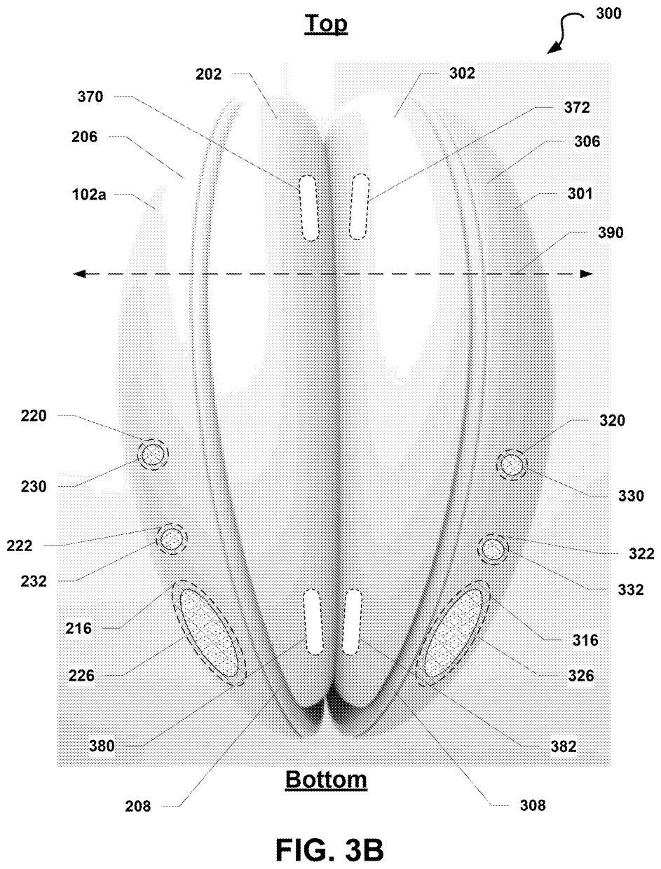

FIGS. 3A and 3B illustrates exterior views of an audio system 300 that include the first translation device 102a and the second translation device 102b. FIG. 3A illustrates an anterior view of the audio system 300, and FIG. 3B illustrates a posterior view of the audio system 300. The first translation device 102a may be configured according to various embodiments previously described herein (e.g., with reference to FIGS. 1A-2B). With reference to FIGS. 3A-3B, the second translation device 102b may be configured as a mirror-image of the first translation device 102a. In some embodiments, the second translation device 102b may include, but is not limited to including: an attachment body 302, a device body 306, a hinge 312, a touch plate 314, an edge member 308, microphones 318, 322, 324, a lighting element 320, microphone ports 328, 332, 334, lighting port 330, a second speaker system 316, and a speaker port 326. In some embodiments, the above elements of the second translation device 102b may be configured as mirror images of the attachment body 202, the device body 206, the hinge 212, the charging connector 242, the touch plate 214, an edge member 208 thereof, the microphones 218, 222, 224, the lighting element 220, the microphone ports 228, 232, 234, the lighting port 230, the second speaker system 216, and the speaker port 226 of the first translation device 102a, respectively. For ease of description, duplicative descriptions of such elements are omitted. In some embodiments (not shown), the second translation device 102b may include one or more other features or components that are configured as mirror images of features or components of the first translation device 102a, including but not limited to, a processing unit, ear pad, ear-fitting attachment, a first speaker system configured to project sound through the ear pad, or various other elements or features similar to those described as being included or coupled to the first translation device 102a (e.g., as described with reference to FIGS. 1A-2B).

The translation devices 102a, 102b may be configured to be coupleable together. In some embodiments, the translation devices 102a, 102b may be configured to include one or more coupling devices in their respective attachment bodies 202, 302. Specifically, in the example illustrated in FIG. 3B, the attachment body 202 may include or be coupled to a first coupling device 370 positioned near a top of the attachment body 202 and a second coupling device 380 positioned near a bottom of the attachment body 202. Similarly, the attachment body 302 may include or be coupled to a third coupling device 372 positioned near a top of the attachment body 302 and a fourth coupling device 382 positioned near a bottom of the attachment body 302. The translation devices 102a, 102b may be coupled together by causing the first and third coupling devices 370, 372 to engage and/or by causing the second and fourth coupling devices 380, 382 to engage. The coupling devices 370, 372, 380, 382 may be one or more (or a combination of) fasteners, magnets, snaps, or the like. By way of a non-limiting example, the coupling devices 370, 372, 380, 382 may be magnets, whereby at least the first coupling device 370 has a different magnetic polarity from the third coupling device 372 and the second coupling device 380 has a different magnetic polarity from the fourth coupling device 382. One or more other coupling devices may be utilized to couple the translation devices 102a, 102b together. The coupling devices 370, 372, 380, 382 may also be configured to allow the translation devices 102a, 102b to be decoupled, for example, when the translation devices 102a, 102b are pulled apart (e.g., along different directions of a referential line 390).

In some embodiments, the translation devices 102a, 102b may be in electronic communication with each other (e.g., via a wireless communication signal, such as Bluetooth or near-field magnetic induction). In such embodiments, respective processing units (not show) of the translation devices 102a, 102b may coordinate in order to play out synchronized sound through the speaker systems 216, 316. For example, the second speaker systems 216, 316 may play out music or other sounds at volumes that may be heard by nearby listeners (e.g., in the same room, house, or the like). In some embodiments, the first speaker system 210 of the first translation device 102a and the first speaker system (not shown) of the second translation device 102b may similarly be configured to play out synchronized sound.

In some embodiments, the translation devices 102a, 102b may, respectively, include sensors 321, 323, as shown in FIG. 3A. Each of the sensors 321, 323 may be configured to detect the presence of the other sensor or another element. The sensors 321, 323 may each be in communication with a processing unit on their respective translation devices 102a, 102b. In some embodiments, when the sensors 321, 323 detect each other (or another element in the other translation device), the sensors 321, 323 may send a signal indicating that the translation devices 102a, 102b are coupled together. In response, the processing units may selectively deactivate features or components on their respective translation devices 102a, 102b, such as the speaker systems 216, 316. For example, the speaker systems 216, 316 may be playing out sound while the translation devices 102a, 102b are not coupled together (e.g., when the sensors 321, 323 do not detect the presence of each other), but the processing units may cause the speaker systems 216, 316 to pause/stop playing out sound when the translation devices 102a, 102b are coupled together (e.g., when the sensors 321, 323 detect the presence of each other). In some embodiments, the processing units may cause features or components on their respective translation devices 102a, 102b to be activated when the sensors 321, 323 do not detect the presence of each other. By way of a non-limiting example, the translation devices 102a, 102b may be in a low-power or “standby” state while they are coupled to each other, but upon decoupling, the processing units may activate or resume operations, activities, functions, features, etc. For example, in response to determining that the sensors 321, 323 no longer detect each other, the processing units may resume communications with each other (and/or another electronic device) and may resume playing out sound via the speaker systems 216, 316.

As described, the first translation device 102a may include one or more microphones (e.g., one or more of the microphones 209, 218, 222, 224 described with reference to FIGS. 2A-2B). In some embodiments, the first translation device 102a may include at least one omnidirectional microphone, which is a microphone configured to have a response that is at least substantially the same regardless of the direction of a source of sound that is received by the microphone. In some additional (or alternative) embodiments, the first translation device 102a may include at least one unidirectional microphone, which is a microphone configured to have a response that is more sensitive in one direction than other directions. In some alternative (or additional) embodiments, the first translation device 102a may include an array of microphones (e.g., two or more microphones) that are configured to perform audio beamforming. As one of ordinarily skill in the art would understand, audio beamforming is a technique in which an array of microphones (typically omnidirectional microphones) are positioned in an orientation in relation to each other (e.g., along an axis) such that the sound captured by each of the microphones in the array along that orientation may be processed together to create an acoustical signal that has a higher signal-to-noise ratio (or various other beneficial characteristics) than an acoustical signal created from sound captured by any of the microphones in the array individually. In some embodiments, the array of microphones included in the first translation device 102a may include two or more omnidirectional microphones.

As also described, the first translation device 102a may include one or more speakers (e.g., one or more of the speaker elements 210, 216 described with reference to FIGS. 2A-3B). In some embodiments, the first speaker element 210 of the first translation device 102a may be configured as a personal-listening speaker and may be positioned on or within the first translation device 102a so that sound outputted from the first speaker element 210 may be heard by the user when the first translation device 102a is secured to the user's ear and, in some embodiments, not heard or barely heard by others near the user. In some additional (or alternative) embodiments, the first translation device 102a may include the second speaker element 216, which may be configured as a group-listening speaker. In such embodiments, the second speaker element 216 may be positioned on or within the first translation device 102a so that sound output from the second speaker 216 may be clearly heard by the user and others in proximity, and as a result, individuals near the first translation device 102a may all hear sound generated from the second speaker element 216 without needing to wear the first translation device 102a.

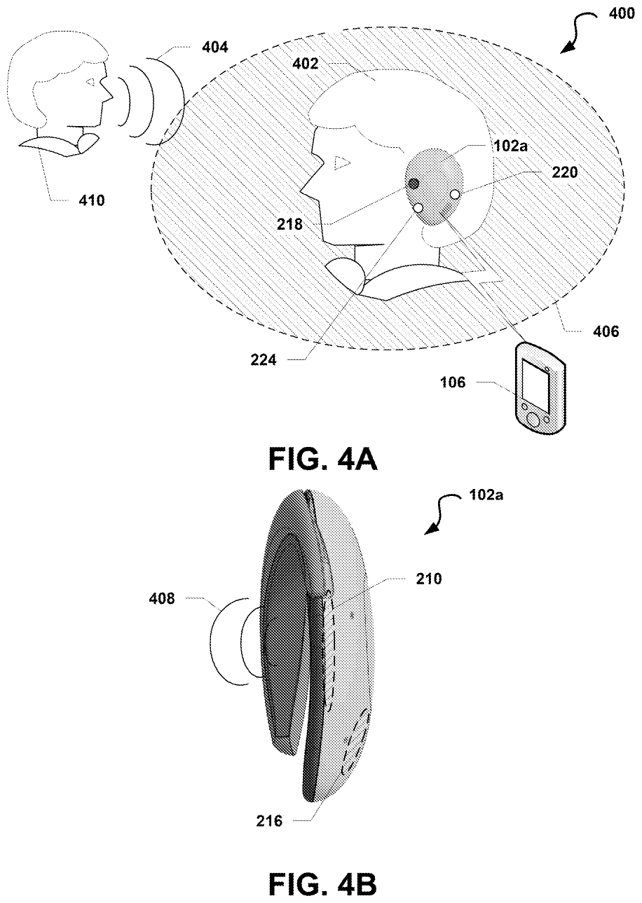

Because the first translation device 102a may include one or more microphones and one or more speakers, the first translation device 102a (and/or the translation system to which the first translation device 102a is included) may operate in various modes to provide superior translation services to a user of the first translation device 102a. Specifically, in some embodiments, the first translation device 102a may be configured to operate selectively in one of a background-listening mode, a foreground-listening mode, a personal-listening mode, and a shared-listening mode. Operating in one of the above modes may be associated with a specific configuration or usage of one or more microphones included in the first translation device 102a. In some additional or alternative embodiments, operating in one of the above modes may be associated with a specific configuration or usage of one or more speakers included in the first translation device 102a. TABLE 1 summarizes some possible configurations of one or more microphones of the first translation device 102a while the first translation device 102a is operating in each of the foregoing modes, according to some embodiments. TABLE 2 summarizes some possible configurations of one or more speakers of the first translation device 102a (e.g., the first speaker element 210 and/or the second speaker element 216) while the first translation device 102a is operating in each of the foregoing modes, according to some embodiments. Further descriptions of configurations and operations of the first translation device 102a (and/or other devices included in the first translation device 102a's translation system) while the first translation device 102a is operating in each of the above modes are provided herein (e.g., at least in reference to FIGS. 4A-14).

TABLE 1-MICROPHONE CONFIGURATIONS

| Translation Device | Background- | Foreground- | Personal- | Shared- |
|---|---|---|---|---|
| Microphone | Listening | Listening | Listening | Listening |
| Configurations | Mode | Mode | Mode | Mode |
| Human Speech | Yes | No | No | Yes |
| Captured Using | | | | |
| Omnidirectional | | | | |
| Microphone(s) | | | | |
| without | | | | |
| Beamforming? | | | | |
| Human Speech | No | Yes | Yes | No |
| Captured Using | | | | |
| Directional | | | | |
| Microphones or | | | | |
| Beamforming | | | | |
| Microphone(s)? | | | | |

TABLE 2-SPEAKER CONFIGURATIONS

| Translation Device | Background- | Foreground- | Personal- | Shared- |
|---|---|---|---|---|
| Speaker | Listening | Listening | Listening | Listening |
| Configurations | Mode | Mode | Mode | Mode |
| First Speaker | Yes | Yes | No | No |
| Element Used to | | | | |
| Playout Captured | | | | |
| Human Speech in | | | | |
| First Spoken | | | | |
| Language? | | | | |
| First Speaker | No | No | Yes | No |
| Used to Playout | | | | |
| Captured Human | | | | |
| Speech in | | | | |
| Second Spoken | | | | |
| Language? | | | | |
| Second Speaker | No | No | No | Yes |
| Element Used | | | | |
| to Playout | | | | |
| Captured Human | | | | |
| Speech in | | | | |
| First Spoken | | | | |
| Language? | | | | |
| Second Speaker | No | Yes | No | Yes |
| Element Used | | | | |
| to Playout | | | | |
| Captured Human | | | | |
| Speech in | | | | |
| Second Spoken | | | | |
| Language? | | | | |

FIGS. 4A-4B are diagrams depicting at least the first translation device 102a operating in a background-listening mode, according to some embodiments. FIG. 4A is a diagram depicting an example operating environment 400 that includes the first translation device 102a configured to operate in a background-listening mode. FIG. 4B is a component diagram depicting operations of one or more speakers of the first translation device 102a while the first translation device 102a is configured to operate in a background-listening mode, according to some embodiments.

In some embodiments, the first translation device 102a may be configured to operate in a background-listening mode to improve the ability of the first translation device 102a (and/or its translation system generally) to provide translation services when a user desires a passive or “always on” translation experience involving continually/continuously translating speech into a language understood by the user. For example, an “always on” translation experience may be suitable for a user of the first translation device 102a who is sightseeing in a foreign country. In this example, the user may desire to have a tour guide's speech translated into a language the user understands continually/continuously without engaging the first translation device 102a (or only without only slight engagement).

In the example illustrated in FIG. 4A, the first translation device 102a may include the microphone 218 and, optionally, the microphones 220 and 224. At least the microphone 218 may be an omnidirectional microphone. While the first translation device 102a is configured to operate in a background-listening mode, the microphone 218 may be configured to capture sound from various directions. For example, the microphone 218 may capture sound 404 that includes human speech originating from a person 410 and may convert the sound 404 into audio data that includes a representation of the captured human speech.

The first translation device 102a may be in communication with the host device 106 (e.g., as described at least with reference to FIGS. 1A-1B). The first translation device 102a may provide the audio data to the speech translation service 166 of the host device 106 (e.g., via a wireless communication). The speech translation service 166 may (individually, jointly, or in conjunction with one or more translation services included on the first translation device 102a or other computing devices in the translation system) at least determine a language of the captured human speech included in the audio data. The speech translation service 166 may then cause audio data including a translated representation of the human speech (e.g., from a second spoken language to a first spoken language) to be generated, either by a processing unit on the host device 106, the first translation device 102a, and/or one or more devices in the translation system. In some embodiments, a first spoken language may be associated with a user 402 of the first translation device 102a and may be set by the user 402 via a user input received on the first translation device 102a (e.g., an audio command setting the first spoken language) and/or via a user input received on the host device 106 (e.g., selection of a language on a user interface). The second spoken language may similarly be selected via a user input or may be determined via one or more known language detection techniques.

With reference to the example illustrated in FIG. 4B, while the first translation device 102a is operating in a background-listening mode, audio data including a translated representation of human speech in a first spoken language may be caused to be played out as sound 408 via the first speaker element 210 of the first translation device 102a (e.g., as described at least with reference to FIGS. 2A-2B). In some embodiments, the first speaker element 210 may be configured as a personal-listening speaker. Accordingly, while the first translation device 102a is secured to the user 402, the user 402 may hear the sound 408 without disturbing others nearby. In some embodiments, the second speaker element 216 of the first translation device 102a (e.g., as described in at least FIG. 2B) may not receive audio data for playout while the first translation device 102a is operating in a background-listening mode. In such embodiments, while the first translation device 102a is operating in a background-listening mode, the second speaker element 216 may be deactivated (e.g., placed into a low-power or inactive state) such that no sound is played via the second speaker element 216 in a background-listening mode, or the second speaker element 216 may remain in an active, high-power state but may be configured not to play out audio data that includes a translated representation of human speech. Thus, while the first translation device 102a is operating in the background-listening mode, the first translation device 102a may continually/continuously playout sound including translated human speech in a first spoken language understood by the user 402.

In some embodiments (not shown), the first translation device 102a may be configured to utilize one or more omnidirectional, non-beamforming microphones to capture ambient sound. Such ambient sound may be amplified and played back through one or more speakers of the translation device 102a. In some embodiments, the translation device 102a may utilize one or more omnidirectional, beamforming (or directional) microphones to capture speech from the user of the first translation device 102a. In such embodiments, the translation device 102a may (directly or indirectly via the host device 106, the network computing device 116, and/or one or more other computing devices) may utilize audio data generated using the one or more omnidirectional, beamforming (or directional) microphones to attenuate (or eliminate) sound of the user's voice. Specifically, the first translation device 102a (directly or indirectly as noted above) may perform noise-cancelling or noise-attenuating techniques using the sound of the user's voice captured with the one or more omnidirectional, beamforming (or directional) microphones to cancel or attenuate the presence of the user' voice in captured using the one or more omnidirectional, non-beamforming microphones. By cancelling or attenuating the sound of the user's voice, the gain/volume of the sound captured using the one or more omnidirectional, non-beamforming microphones may be increased to allow the user to experience ambient sound more intensely while mitigating the likelihood that the user's own voice will be overly represented (e.g., too loud) when played out via the one or more speakers of the translation device 102a.

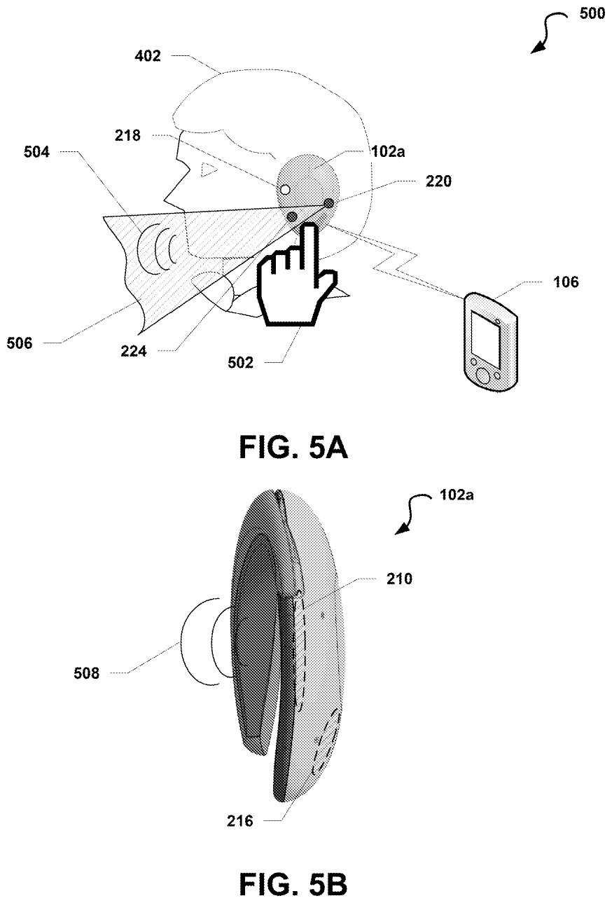

FIGS. 5A-5B are diagrams depicting at least the first translation device 102a operating in a personal-listening mode, according to some embodiments. FIG. 5A is a diagram depicting an example operating environment 500 that includes the first translation device 102a configured to operate in a personal-listening mode. FIG. 5B is a component diagram depicting operations of one or more speakers of the first translation device 102a while the first translation device 102a is configured to operate in a personal-listening mode, according to some embodiments.

In some embodiments, the first translation device 102a may be configured to operate in a personal-listening mode to enable a user to translate the user's speech into another language (e.g., from a first spoken language to a second spoken language), such as when a user of the first translation device 102a desires to have the user's own speech translated into a foreign language so that the user may know how to say a certain word, phrase, or other utterance in that language. In a non-limiting example, an English user of the first translation device 102a may want to know how to order a meal in French while the user is visiting France.

As described, the first translation device 102a may include the microphones 218, 220, and 224. In some embodiments, at least two microphones on the first translation device 102a may be omnidirectional microphones configured to implement beamforming techniques in a direction of the user's face while the first translation device 102a is secured to the user's ear (sometimes referred to herein for ease of description as a “front-side direction”). In some alternative (or additional) embodiments, at least one microphone on the first translation device 102a may be a directional microphone configured to capture sound in a front-side direction. In the example illustrated in FIG. 4A, the microphones 220 and 224 may be omnidirectional microphones that are configured to implement beamforming techniques such that the microphones 220 and 224 are sensitive (or relatively more sensitive) to sound originating from a front-side direction (e.g., as represented by a shaded area 506). While the first translation device 102a is configured to operate in a personal-listening mode, the microphones 220, 224 may be configured to capture sound 504 that includes human speech originating from the user 402 of the first translation device 102a and may generate audio data including such human speech.

In some embodiments, the first translation device 102a may transition from a background-listening mode (e.g., as described at least with reference to FIGS. 4A-4B) to a personal-listening mode via a user input 502. By way of a non-limiting example illustrated in FIG. 5A, the first translation device 102a may receive a touch input 502 from the user 402, which may cause the first translation device 102a to transition from a background-listening mode (e.g., as described at least with reference to FIGS. 4A-4B) to a personal-listening mode. In some embodiments, the first translation device 102a may transition from a background-listening mode to a personal-listening mode by causing one or more of the microphones to be configured to capture sound from a front-side direction. In some additional embodiments, the first translation device 102a may also selectively deactivate one or more omnidirectional microphones that are not configured to capture sound preferentially form a front-side direction. In some embodiments, the first translation device 102a may transition from the personal-listening mode to the background-listening mode in response to receiving another user input or in response to determining that a user input has been removed (e.g., when a touch sensor on the first translation device 102a determines that the touch input 502 has been removed)

The first translation device 102a may be in communication with the host device 106 (e.g., as described at least with reference to FIGS. 1A-1B). The first translation device 102a may provide the audio data to the speech translation service 166 of the host device 106 (e.g., via a wireless communication). The speech translation service 166 may (individually, jointly, or in conjunction with one or more translation services included on the first translation device 102a or other computing devices in the translation system) at least determine a language of the captured human speech included in the audio data. The speech translation service 166 may then cause audio data including a translated representation of the human speech (e.g., from a first spoken language to a second spoken language) to be generated, either by a processing unit on the host device 106, the first translation device 102a, and/or one or more devices in the translation system. In some embodiments, a first spoken language may be associated with a user 402 of the first translation device 102a and may be set by the user 402 via a user input received on the first translation device 102a (e.g., an audio command setting the first spoken language) and/or via a user input received on the host device 106 (e.g., selection of a language on a user interface). The second spoken language may similarly be selected via a user input or may be determined via one or more known language detection techniques.

In some embodiments (not shown), the first translation device 102a may be caused to transition from a background-listening mode to a personal-listening mode by the host device 106. In a non-limiting example, the host device 106 may receive a user input (e.g., a touch input, voice input, electronic command, or the like), and in response, the host device 106 may send instructions to the first translation device 102a that cause the first translation device 102a to transition to the personal listening mode.

With reference to the example illustrated in FIG. 5B, while the first translation device 102a is operating in a personal-listening mode, audio data including a translated representation of human speech in a second spoken language may be caused to be played out as sound 508 via the first speaker element 210 of the first translation device 102a (e.g., as described at least with reference to FIGS. 2A-2B). In some embodiments, the first speaker element 210 may be configured as a personal-listening speaker. Accordingly, while the first translation device 102a is secured to the user 402, the user 402 may hear the sound 508 without disturbing others nearby. In some embodiments, the second speaker element 216 of the first translation device 102a (e.g., as described in at least FIG. 2B) may not receive audio data for playout while the first translation device 102a is operating in a personal-listening mode. In such embodiments, while the first translation device 102a is operating in a personal-listening mode, the second speaker element 216 may be deactivated (e.g., placed into a low-power or inactive state) such that no sound is played via the second speaker element 216 in a personal-listening mode, or the second speaker element 216 may remain in an active, high-power state but may be configured not to play out audio data that includes a translated representation of human speech. Thus, while the first translation device 102a is operating in the personal-listening mode, the first translation device 102a may continually/continuously playout sound including translated human speech in a first spoken language understood by the user 402.

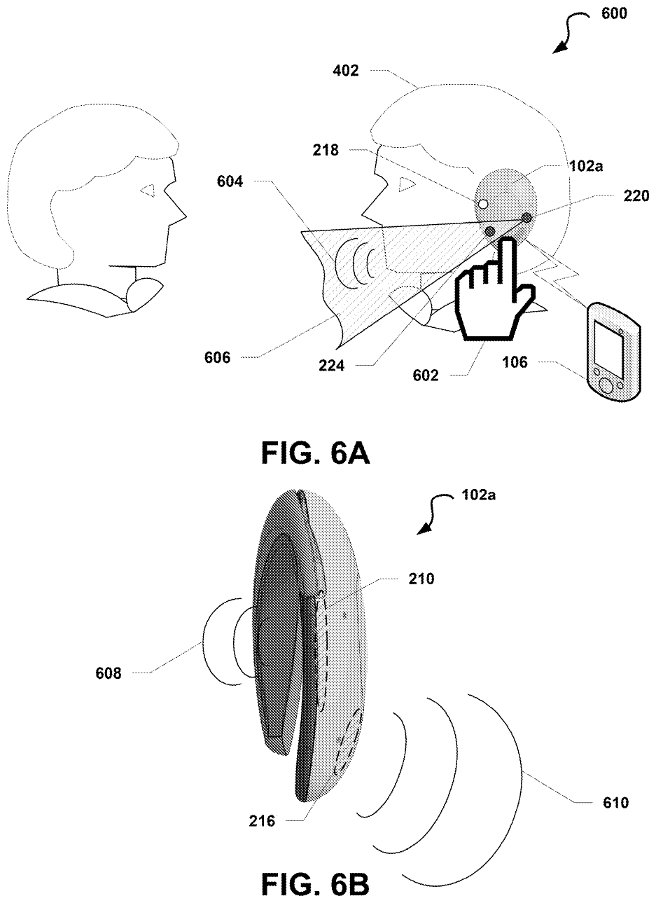

FIGS. 6A-6B are diagrams depicting at least the first translation device 102a operating in a foreground-listening mode, according to some embodiments. FIG. 6A is a diagram depicting an example operating environment 600 that includes the first translation device 102a configured to operate in a foreground-listening mode. FIG. 6B is a component diagram depicting operations of one or more speakers of the first translation device 102a while the first translation device 102a is configured to operate in a foreground-listening mode, according to some embodiments.

In some embodiments, the first translation device 102a may be configured to operate in a foreground-listening mode to enable a user to converse with another person in another language (e.g., from a first spoken language to a second spoken language). In a non-limiting example, an English user of the first translation device 102a may wish to have the user's speech translated into Spanish while speaking with a person who understands Spanish.

As described, the first translation device 102a may include the microphones 218, 220, and 224. In some embodiments, at least two microphones on the first translation device 102a may be omnidirectional microphones configured to implement beamforming techniques in a front-side direction of the user's face while the first translation device 102a is secured to the user's ear. In some alternative (or additional) embodiments, at least one microphone on the first translation device 102a may be a directional microphone configured to capture sound in a front-side direction. In the example illustrated in FIG. 6A, the microphones 220 and 224 may be omnidirectional microphones that are configured to implement beamforming techniques such that the microphones 220 and 224 are sensitive (or relatively more sensitive) to sound originating from a front-side direction (e.g., as represented by a shaded area 606). While the first translation device 102a is configured to operate in a foreground-listening mode, the microphones 220, 224 may be configured to capture sound 604 that includes human speech originating from the user 402 of the first translation device 102a and may generate audio data including such human speech.

In some embodiments, the first translation device 102a may transition from a background-listening mode (e.g., as described at least with reference to FIGS. 4A-4B) to a foreground-listening mode via a user input 602. By way of a non-limiting example illustrated in FIG. 6A, the first translation device 102a may receive a touch input 602 from the user 402, which may cause the first translation device 102a to transition from a background-listening mode (e.g., as described at least with reference to FIGS. 4A-4B) to a foreground-listening mode. In some embodiments, the first translation device 102a may transition from a background-listening mode to a foreground-listening mode at least in part by causing one or more of the microphones to be configured to capture sound from a front-side direction. In some additional embodiments, the first translation device 102a may also selectively deactivate one or more omnidirectional microphones that are not configured to capture sound preferentially form a front-side direction. In some embodiments, the first translation device 102a may transition from the foreground-listening mode to the background-listening mode in response to receiving another user input or in response to determining that a user input has been removed (e.g., when a touch sensor on the first translation device 102a determines that the touch input 602 has been removed)

The first translation device 102a may be in communication with the host device 106 (e.g., as described at least with reference to FIGS. 1A-1B). The first translation device 102a may provide the audio data to the speech translation service 166 of the host device 106 (e.g., via a wireless communication). The speech translation service 166 may (individually, jointly, or in conjunction with one or more translation services included on the first translation device 102a or other computing devices in the translation system) at least determine a language of the captured human speech included in the audio data. The speech translation service 166 may then cause first audio data including a translated representation of the human speech in a first spoken language and second audio data including a translated representation of the human speech in a second spoken language to be generated, either by a processing unit on the host device 106, the first translation device 102a, and/or one or more devices in the translation system. In some embodiments, a first spoken language may be associated with a user 402 of the first translation device 102a and may be set by the user 402 via a user input received on the first translation device 102a (e.g., an audio command setting the first spoken language) and/or via a user input received on the host device 106 (e.g., selection of a language on a user interface). The second spoken language may similarly be selected via a user input or may be determined via one or more known language detection techniques.

In some embodiments (not shown), the first translation device 102a may be caused to transition from a background-listening mode to a foreground-listening mode by the host device 106. In a non-limiting example, the host device 106 may receive a user input (e.g., a touch input, voice input, electronic command, or the like), and in response, the host device 106 may send instructions to the first translation device 102a that cause the first translation device 102a to transition to the foreground-listening mode.

With reference to the example illustrated in FIG. 6B, while the first translation device 102a is operating in a foreground-listening mode, audio data including a translated representation of human speech in a first spoken language may be caused to be played out as sound 608 via the first speaker element 210 of the first translation device 102a (e.g., as described at least with reference to FIGS. 2A-2B). In some embodiments, the first speaker element 210 may output sound that includes a representation of the speech of the user 402 in a first spoken language (e.g., the sound 604). In such embodiments, the first translation device 102a may playout sound 608 including a representation of what the first translation device 102a, the host device 106, and/or another device determined the user 402 said in a first spoken language. In other words, the first translation system 102a may play the speech of the user 402 back to the user 402. As described above, automatic speech recognition may sometimes misinterpret the meaning of a user's speech, and the first translation device 102a may therefore play back the user's own speech so that the user 402 may hear if the translation system misinterpreted the meaning of the user's speech.

In some embodiments, the second speaker element 216 of the first translation device 102a (e.g., as described in at least FIG. 2B) may receive audio data including a representation of speech of the user 402 for playout while the first translation device 102a is operating in a foreground-listening mode. Specifically, the first translation device 102a may cause the second speaker element 216 to play out a translated version of the speech of the user 402. Because the second speaker element 216 may be configured as a group-listening device, the sound 610 output from the second speaker element 216 may be heard by the user 402 and others near the first translation device 102a. The first translation device 102a may remain in the foreground-listening mode until the first translation device 102a receives another user input (or, alternatively/additionally, until a user input is discontinued).

In some embodiments, the first translation device 102a may be configured to capture speech from the user 402 while the first translation device 102a is operating in a foreground-listening mode and may receive a user input from the user 402 that causes the first translation device 102a to transition to a background-listening mode. In such embodiments, the first translation device 102a may receive human speech from others nearby the user 402 using one or more omnidirectional microphones while in the background-listening mode and may provide the user with translated versions of that human speech (e.g., as described at least with reference to FIGS. 4A-4B).

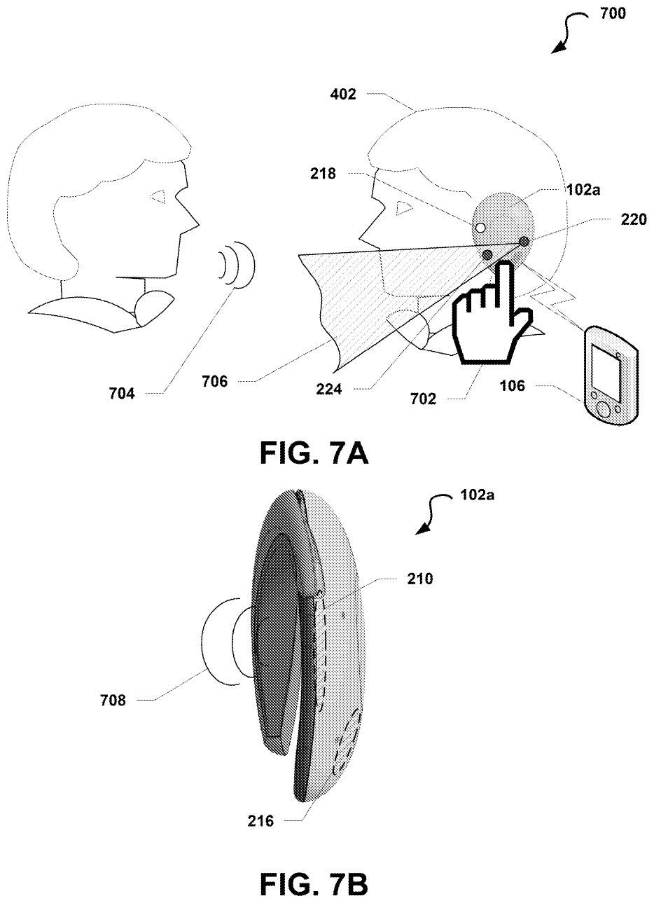

FIGS. 7A-7B are diagrams depicting alternative embodiments in which the first translation device 102a receives human speech from others nearby the user 402 while the first translation device 102a is operating in a foreground-listening mode (e.g., instead of while operating in a background-listening mode). FIG. 7A is a diagram depicting an example operating environment 700 that includes the first translation device 102a configured to receive human speech from others near the user 402 while operating in a foreground-listening mode. FIG. 7B is a component diagram depicting operations of one or more speakers of the first translation device 102a while the first translation device 102a is operating in a foreground-listening mode, according to some embodiments.

With reference to example illustrated in FIG. 7A, the first translation device 102a may be caused to transition to a foreground-listening mode via a user input. In some non-limiting examples, the user input may be a user touch input 702 received on a touch sensor included on the first translation device 102a, a setting enabled on the host device 106 via a user input and communicated from the host device 106 to the first translation device 102a, or the like. While operating in the foreground-listening mode, one or more microphones of the first translation device 102a may be configured to captures speech originating from a front-side of the user 402 (e.g., as described with reference to FIGS. 6A-6B). For example, the microphones 220, 224 may be configured as omnidirectional microphones that implement beamforming techniques to have higher sensitivity towards the front-side direction of the user (e.g., as represented via a shaded area 706). In the example illustrated in FIG. 7A, the microphones 220, 224 may capture sound 704 that includes human speech in a second spoken language and may generate audio data that includes a representation of that human speech.

In some embodiments, at least one of the first translation device 102a, the host device 106, or another device (e.g., a network computing device 116) may determine that the speech included in the audio data is in a second spoken language. For example, at least one of those devices may utilize known speech detection techniques to determine that the human speech is in a second spoken language or may make such determination based on a user setting previously selected by the user 402. In response to determining that speech in a second spoken language was captured by the first translation device 102a while the first translation device 102a is operating in the foreground operating mode, at least one of the first translation device 102a, the host device 106, or another device (e.g., a network computing device 116) may generate audio data including a translated representation of the human speech 704 in a first spoken language.

With reference to the example illustrated in FIG. 7B, the first translation device 102a may obtain the audio data including the translated representation of the human speech 704 in a first spoken language. For example, the host device 106 may provide such audio data to the first translation device 102a via a wireless communication. Because the first translation device 102a is operating in a foreground-listening mode, the first translation device 102a may cause the first speaker element 210 to play out the audio data including the translated representation of the human speech 704 in a first spoken language. As described, the first speaker element 210 may be configured a personal-listening speaker, which may enable the user 402 to hear the translated speech without disturbing others nearby. In some embodiments, the first translation device 102a may not provide the second speaker element 216 with audio data having a representation of human speech translated into a first spoken language.

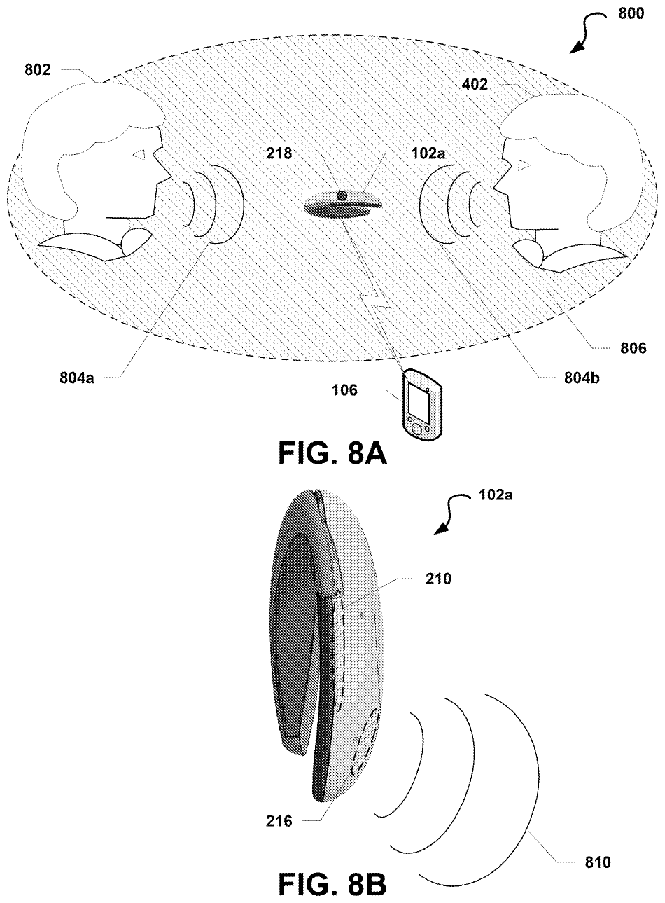

FIGS. 8A-8B are diagrams depicting the first translation device 102a operating in a shared-listening mode, according to some embodiments. FIG. 8A is a diagram depicting an example operating environment 800 that includes the first translation device 102a configured to operate in a shared-listening mode. FIG. 8B is a component diagram depicting operations of one or more speakers of the first translation device 102a while the first translation device 102a is configured to operate in a shared-listening mode, according to some embodiments.

In some embodiments, the first translation device 102a may be configured to operate in a shared-listening mode to enable multiple users to translate speech into multiple languages (e.g., from a first spoken language to a second spoken language, and vice versa). In a non-limiting example, an English user of the first translation device 102a may converse with a French user, and the first translation device 102a may translate the English user's speech into French and the French user's speech into English.

In the example illustrated in FIG. 8A, at least one of the microphones included on the first translation device 102a may be configured as an omnidirectional microphone (e.g., the microphone 218). While the first translation device 102a is configured to operate in a shared-listening mode, the microphone 218 may capture speech from various directions (e.g., as represented by a shaded area 806) originating from one or more individuals near the first translation device 102a. For example, the microphone 218 may capture speech 804b in a first spoken language from the user 402 and may capture speech 804a in a second spoken language from a user 802. The microphone 218 may generate audio data from the human speech 804a, 804b.

In some embodiments, the first translation device 102a may transition from a background-listening mode (e.g., as described at least with reference to FIGS. 4A-4B) to a shared-listening mode via a user input (not shown). By way of a non-limiting example, while the first translation device 102a is operating in a background-listening mode, the first translation device 102a may receive a touch input from the user 402, which may cause the first translation device 102a to transition from the background-listening mode to a shared-listening mode. In some embodiments, the first translation device 102a may transition from a background-listening mode to a shared-listening mode at least in part by causing one or more of the microphones to be configured to capture sound omnidirectionally (if not already configured as such).

The first translation device 102a may be in communication with the host device 106 (e.g., as described at least with reference to FIGS. 1A-1B). The first translation device 102a may provide the audio data to the speech translation service 166 of the host device 106 (e.g., via a wireless communication). The speech translation service 166 may (individually, jointly, or in conjunction with one or more translation services included on the first translation device 102a or other computing devices in the translation system) at least determine a language of the captured human speech included in the audio data. The speech translation service 166 may then cause audio data including a translated representation of the human speech (e.g., from a first spoken language to a second spoken language) to be generated, either by a processing unit on the host device 106, the first translation device 102a, and/or one or more devices in the translation system. In some embodiments, a first spoken language may be associated with a user 402 of the first translation device 102a and a second spoken language may be associated with the user 802. In some embodiments, these associations may be set via a user input received on the first translation device 102a (e.g., an audio command setting the first spoken language) and/or via a user input received on the host device 106 (e.g., selection of a language on a user interface).

In some embodiments (not shown), the first translation device 102a may be caused to transition from a background-listening mode to a shared-listening mode by the host device 106. In a non-limiting example, the host device 106 may receive a user input (e.g., a touch input, voice input, electronic command, or the like), and in response, the host device 106 may send instructions to the first translation device 102a that cause the first translation device 102a to transition to the shared-listening mode.

With reference to the example illustrated in FIG. 8B, while the first translation device 102a is operating in a shared-listening mode, audio data including a translated representation of human speech in one of a first or second spoken language may be caused to be played out as sound 810 via the second speaker element 216 of the first translation device 102a (e.g., as described at least with reference to FIGS. 2A-2B). In some embodiments, the second speaker element 216 may be configured as a group-listening speaker. Accordingly, both the user 402 and the user 802 may hear the sound 810 while near the first translation device 102a. By way of a non-limiting example, the speech 804b of the user 402 may be determined to be in a first spoken language, and audio data including a representation of the speech 804a in a second spoken language may be caused to be played out of the second speaker element 216 as the sound 810. Similarly, the speech 804a of the user 802 may be determined to be in a second spoken language, and audio data including a representation of the speech 804a in a first spoken language may be caused to be played out of the second speaker element 216 as the sound 810. Thus, the first translation device 102a may function as an “interpreter” that enables the users 402, 802 to understand each other.

In some embodiments, the first speaker element 210 of the first translation device 102a (e.g., as described in at least FIG. 2B) may not receive audio data for playout while the first translation device 102a is operating in a shared-listening mode. In such embodiments, while the first translation device 102a is operating in a shared-listening mode, the first speaker element 210 may be deactivated (e.g., placed into a low-power or inactive state) such that no sound is played via the second speaker element 216 in a shared-listening mode, or the first speaker element 210 may remain in an active, high-power state but may be configured not to play out audio data that includes a translated representation of human speech.

In some embodiments, the first speaker element 210 of the first translation device 102a (e.g., as described in at least FIG. 2B) may receive audio data for playout while the first translation device 102a is operating in a shared-listening mode to supplement or augment the sound 810 played out of the second speaker element 216. In such instances, the first speaker element 210 may be configured to operate as a low-range, group-listening speaker, and the second speaker element 216 may be configured to operate as a high-range, group-listening speaker. For example, the first speaker may be configured to produce sound frequencies substantially in the range of 20 Hz to 2000 Hz when operating as a low-range, group-listening speaker, and the second speaker may be configured to produce sound frequencies substantially in the range of 2000 Hz to 20,000 Hz while operating as a high-range, group-listening speaker.

While various embodiments described herein (e.g., with reference at least to FIGS. 4A-8B) reference operations and configurations of the first translation device 102a, the second translation device 102b may be similarly configured (e.g., as a mirror-image of the first translation device 102a). In some embodiments, the first translation device 102a and the second translation device 102b may be configured to operate jointly to implement one or more of the embodiments described above. Specifically, without limiting any of the foregoing descriptions, one or both of the first translation device 102a and the second translation device 102b may be configured to capture human speech and output translated versions as sound via one or more speakers on each the first translation device 102a and the second translation device 102b according to any one of a background-listening mode, personal-listening mode, foreground-listening mode, and/or shared-listening mode (e.g., as described generally with reference to FIG. 4A-8B).

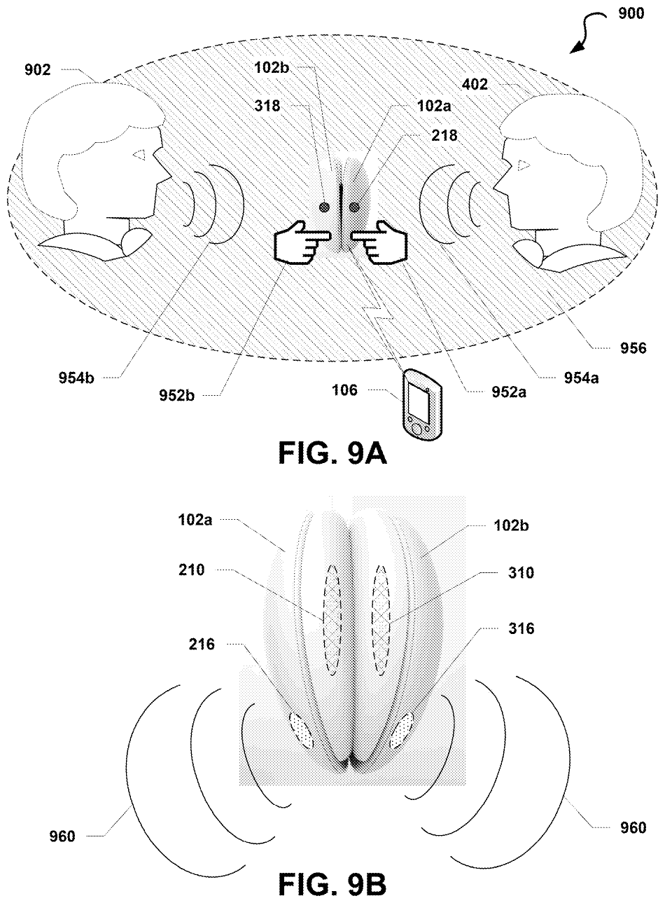

FIGS. 9A-9B are diagrams depicting the first translation device 102a and the second translation device 102b operating jointly in a shared-listening mode, according to some alternative embodiments. FIG. 9A is a diagram depicting an example operating environment 900 that includes the first translation device 102a and the second translation device 102b collectively configured to receive human speech while operating in a shared-listening mode. FIG. 9B is a component diagram depicting playout of translated human speech from the first translation device 102a and the second translation device 102b while they are operating in a shared-listening mode, according to some embodiments.

In some embodiments, the first translation device 102a and the second translation device 102b may collectively be configured to operate in a shared-listening mode to enable translation of different speech from multiple users. In the example illustrated in FIG. 9A, at least one of the microphones included on the first translation device 102a (and optionally, at least one microphone included on the second translation device 102b) may be configured as an omnidirectional microphone (e.g., the microphones 218 and 318). While the first translation device 102a and second translation device 102b are configured to operate in a shared-listening mode, at least the microphone 218 may be able to capture speech from various directions (e.g., as represented by a shaded area 956) originating from one or more individuals near the first translation device 102a and the second translation device 102b. For example, the microphone 218 (and/or optionally the microphone 318) may capture speech 954a in a first spoken language from the user 402 and may capture speech 954b in a second spoken language from a user 902. The microphone 218 (and/or optionally the microphone 318) may generate separate audio data from the human speech 954a, 954b.

In some embodiments, the first translation device 102a may activate the microphone 218 in response to receiving a user input 952a (e.g., from the user 402). By way of a non-limiting example, while the user input 952a is being received (e.g., while a touch sensor detects a touch input), the first translation device 102a may cause the microphone 218 to be activated in order to capture speech. In some additional (or alternative) embodiments, the second translation device 102b may activate the microphone 318 in response to receiving a user input 952b. By way of a non-limiting example, while the user input 952a is being received (e.g., while a touch sensor detects a touch input), the first translation device 102a may cause the microphone 218 to be activated in order to capture speech. In some embodiments, speech captured via the microphone 218 may be associated with a first spoken language, and speech captured via the microphone 318 may be associated with a second spoken language.

In some embodiments, the first translation device 102a may transition from a background-listening mode (e.g., as described at least with reference to FIGS. 4A-4B) to a shared-listening mode via a user input (not shown). By way of a non-limiting example, while the first translation device 102a (and, optionally, the second translation device 102b) is operating in a background-listening mode, the first translation device 102a (and/or the second translation device 102b) may receive a touch input from a user, which may cause the first translation device 102a (and/or the second translation device 102b) to transition from the background-listening mode to a shared-listening mode. In some embodiments, the first translation device 102a and/or the second translation device 102b may transition from a background-listening mode to a shared-listening mode at least in part by causing one or more of their microphones to be configured to capture sound omnidirectionally (if not already configured as such).

In some embodiments, when the user input 952a is no longer received (e.g., when a touch sensor is no longer detected), the first translation device 102a may cause the microphone 218 to no longer capture speech until another user input is received. Similarly, when the user input 952b is no longer received on the second translation device 102b (e.g., when a touch sensor is no longer detected), the second translation device 102b may cause the microphone 318 to no longer capture speech until another touch input is received. In some alternative embodiments, while no user input is received, the first translation device 102a may discard audio data generated from the microphone 218. Similarly, the second translation device 102b may discard audio data generated from the microphone 318 while no user input is received.

The first translation device 102a may be in communication with the host device 106 (e.g., as described at least with reference to FIGS. 1A-1B). The second translation device 102b may be in communication with the host device 106 directly or indirectly via the first translation device 102a. The first translation device 102a and second translation device 102b may provide audio data including human to the speech translation service 166 of the host device 106 (e.g., via a wireless communication). The speech translation service 166 may (individually, jointly, or in conjunction with one or more translation services included on the first translation device 102a or other computing devices in the translation system) at least determine a language of the captured human speech included in the audio data. The speech translation service 166 may then cause audio data including a translated representation of the human speech (e.g., from a first spoken language to a second spoken language) to be generated, either by a processing unit on the host device 106, the first translation device 102a, and/or one or more devices in the translation system.

In some embodiments, the first translation device 102a may be associated with a first spoken language, and a second spoken language may be associated with the second translation device 102b. The speech translation service 166 may utilize such associations in an attempt to translate speech from one language to another language. By way of a non-limiting example, the speech translation service 166 may obtain audio data including human speech in a first spoken language originating from the first translation device 102a (e.g., captured via the microphone 218). The speech translation service 166 may determine a second spoken language associated the second translation device 102b and may provide audio data including a translation of the human speech in a second spoken language to the second translation device 102b from output as sound. In the above example, the speech translation service 166 may similarly obtain audio data including human speech in a second spoken language originating from the second translation device 102b (e.g., captured via the microphone 318). The speech translation service 166 may determine a first spoken language associated the first translation device 102a and may provide audio data including a translation of the human speech in a first spoken language to the second translation device 102b from output as sound. In such embodiments, these associations may be set via a user input received on the first translation device 102a (e.g., an audio command setting the first spoken language) and/or via a user input received on the host device 106 (e.g., selection of a language on a user interface).

In some embodiments (not shown), the first translation device 102a may be caused to transition from a background-listening mode to a shared-listening mode by the host device 106. In a non-limiting example, the host device 106 may receive a user input (e.g., a touch input, voice input, electronic command, or the like), and in response, the host device 106 may send instructions to the first translation device 102a that cause the first translation device 102a to transition to the shared-listening mode.

With reference to the example illustrated in FIG. 9B, while the first translation device 102a is operating in a shared-listening mode, audio data including a translated representation of human speech in one of a first or second spoken language may be caused to be played out as sound 960 via the second speaker element 216 of the first translation device 102a (e.g., as described at least with reference to FIGS. 2A-2B). In some embodiments, the second speaker element 216 may be configured as a group-listening speaker. Accordingly, both the user 402 and the user 902 may hear the sound 960 while near the first translation device 102a. By way of a non-limiting example, the speech 954a of the user 402 may be determined to be in a first spoken language, and audio data including a representation of the speech 954a in a second spoken language may be caused to be played out of the second speaker element 216 as the sound 960. Similarly, the speech 954b of the user 902 may be determined to be in a second spoken language, and audio data including a representation of the speech 954b in a first spoken language may be caused to be played out of the second speaker element 216 as the sound 960. Thus, the first translation device 102a may function as an “interpreter” that enables the users 402, 902 to understand each other.

In some embodiments, the first speaker element 210 of the first translation device 102a (e.g., as described in at least FIG. 2B) may not receive audio data for playout while the first translation device 102a is operating in a shared-listening mode. In such embodiments, while the first translation device 102a is operating in a shared-listening mode, the first speaker element 210 may be deactivated (e.g., placed into a low-power or inactive state) such that no sound is played via the second speaker element 216 in a shared-listening mode, or the first speaker element 210 may remain in an active, high-power state but may be configured not to play out audio data that includes a translated representation of human speech.

In some embodiments, the first speaker element 210 of the first translation device 102a (e.g., as described in at least FIG. 2B) may receive audio data for playout while the first translation device 102a is operating in a shared-listening mode to supplement or augment the sound 960 played out of the second speaker element 216. In such instances, the first speaker element 210 may be configured to operate as a low-range, group-listening speaker, and the second speaker element 216 may be configured to operate as a high-range, group-listening speaker. For example, the first speaker may be configured to produce sound frequencies substantially in the range of 20 Hz to 2000 Hz when operating as a low-range, group-listening speaker, and the second speaker may be configured to produce sound frequencies substantially in the range of 2000 Hz to 20,000 Hz while operating as a high-range, group-listening speaker.

While the examples illustrated in FIGS. 9A-9B depict the first translation device 102a and the second translation device 102b coupled together, in some embodiments, the first translation device 102a and the second translation device 102b may perform one or more of the operations described above while decoupled. In some embodiments, the first translation device 102a and the second translation device 102b may transition to a shared-listening mode in response to coupling the first translation device 102a and the second translation device 102b together.

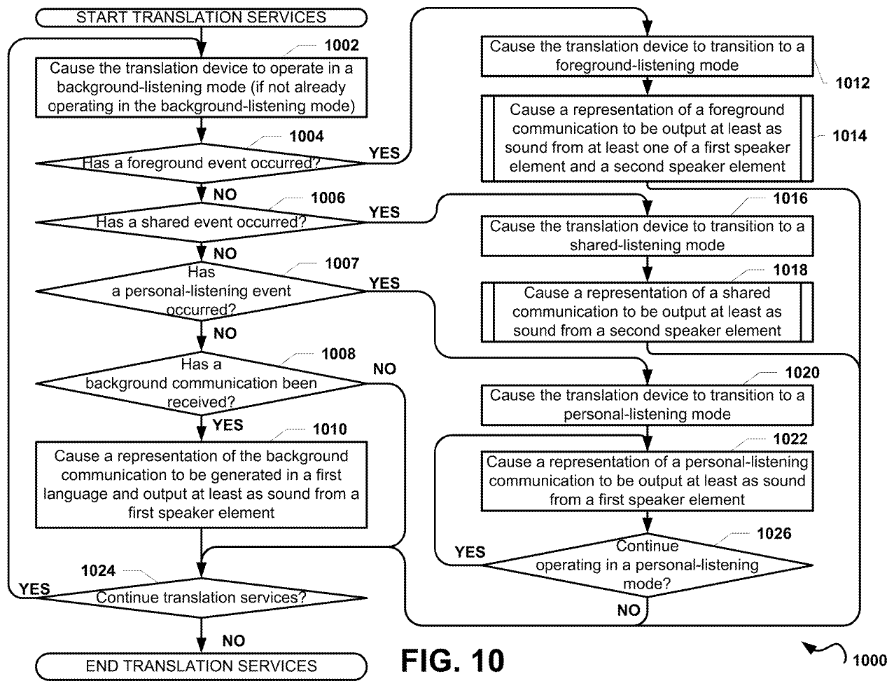

FIG. 10 is a flow diagram depicting an illustrative computer-implemented method or routine 1000, according to some embodiments. In some embodiments, the routine 1000 may be implemented by a translation service operating on a translation device (e.g., the translation service 166 of the translation device 102a as described with reference to FIGS. 1B-9B). The translation service 166 may begin performing the routine 1000 in block 1002.

In block 1002, the translation service 166 may cause the translation device 102a to operate in a background-listening mode if the translation device 102a is not already operating in the background-listening mode. In some embodiments, the translation service 166 may send a communication to a processing unit on the translation device 102a (e.g., the processing unit 240 as described with reference to FIGS. 2A-2B) instructing the processing unit 240 to configure at least one omni-directional microphone included on the translation device 102a to be able to capture sound. By way of a non-limiting example, the communication may cause the processing unit 240 on the translation device 102a to configure an omnidirectional microphone (e.g., one or more of the microphones 209, 218, 220, 224 as described with reference to FIGS. 2A-2B) to transition from a low-power, standby state in which such microphone does not capture sound (or in which captured sound is discarded) to a high-power, active state in which such microphone captures sound for processing. In some embodiments, while the translation device 102a is operating in a background listening mode, the instructions may cause the processing unit 240 to configure the at least one omnidirectional microphone not to implement beamforming techniques and, instead, may configure the at least one omnidirectional microphone to capture sound from various directions with at least substantially the same responsiveness.

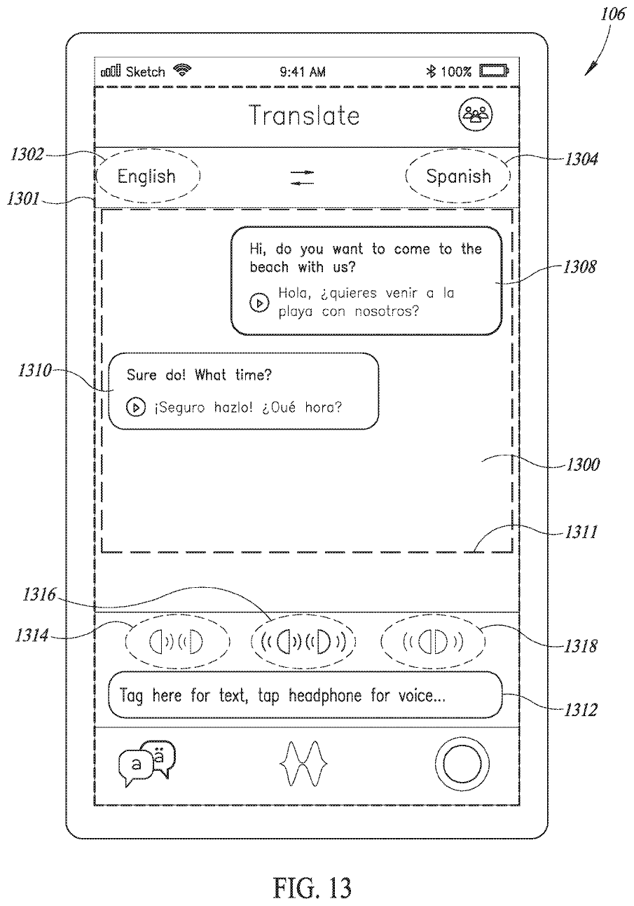

In determination block 1004, the translation service 166 may determine whether a foreground event has occurred. In some embodiments, the translation service 166 may determine that a foreground event has occurred in response to determining that a user input has been received on the host device 106 (e.g., on a user interface as further described at least with reference to FIG. 13). In such embodiments, the user input may be a selection of an interactive element included on a user interface that is associated with a foreground-listening mode (e.g., a selectable icon representing a foreground-listening mode). In some alternative or additional embodiments, the translation service 166 may determine that a foreground event has occurred in response to determining that a user input has been received on the translation device 102a (e.g., as detected by a touch sensor of a touch plate 214, as described at least with reference to FIGS. 2A-2B).

In some further embodiments, the translation service 166 may determine that a foreground event has occurred in response to determining both that a user selection of a foreground-listening mode has been received on a user interface of the host device 106 and that a user input has been received on the translation device 102a. In such embodiments, the selection of a foreground-listening mode on the user interface of the host device 106 may identify an operation mode that the translation service 166 will cause the translation device 102a to transition to while operating in a background-listening mode; however, the translation service 166 may determine that a foreground-listening event has occurred only in response to determining that a user input is received on (and in some embodiments, only while such input is continued to be received on) the translation device 102a. In some embodiments, while a user input is not received on the translation device 102a, the translation service 166 may not determine that a foreground-listening event has occurred, and the translation device 102a may instead continue operating in a background-listening mode. Accordingly, when a user input is received on the translation device 102a (e.g., when a user taps the touch plate 214 of the translation device 102a), the translation device 102a may provide a notification of the user input received on the translation device 102a to the translation service 166, and in response, the translation service 166 may determine that a foreground event has occurred, thereby implementing an on-demand or “push-to-translate” experience for a user.

In response to determining that a foreground event has occurred (i.e., determination block 1004=“YES”), the translation service 166 may cause the translation device 102a to transition to a foreground-listening mode from the background-listening mode, in block 1012. In some embodiments, the translation service 166 may cause the translation device to translation to a foreground-listening mode at least in part by sending a communication to the processing unit 240 on the translation device 102a instructing the processing unit 240 to activate at least one directional microphone and/or a plurality of omnidirectional microphones configured to implement beamforming techniques. In such embodiments, the processing unit 240 may activate the at least one direction microphone and/or the plurality of omnidirectional microphones by causing such microphones to transition from a standby, low-power state to a high-power, active state suitable for capturing and processing sound. In some additional embodiments, the processing unit 240 may deactivate one or more other microphones while the translation device 102a is operating in the foreground-listening mode, for example, by causing those one or more microphones to transition to a standby, low-power state from a high-power, active state and/or by discarding audio data generated using such one or more microphones without utilizing the audio data.

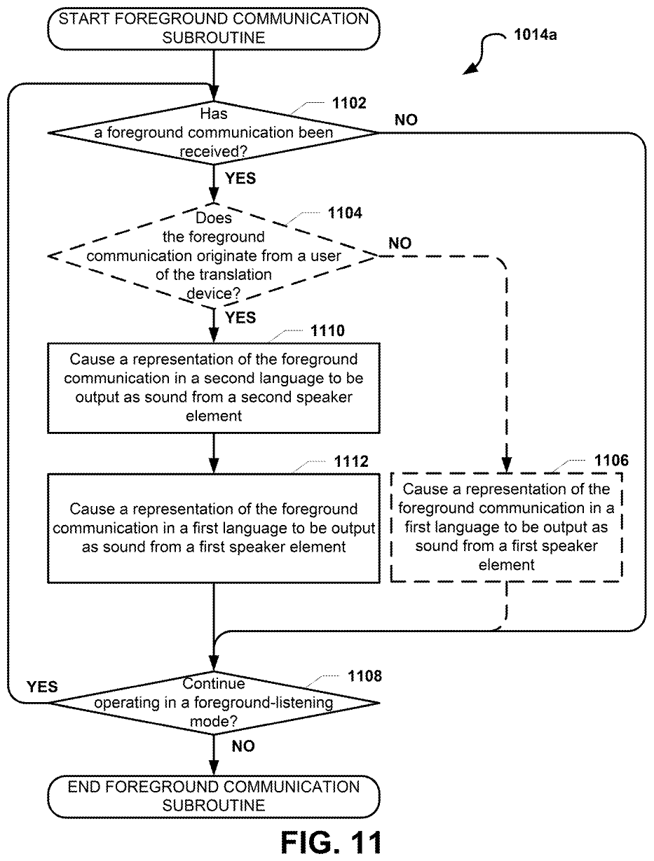

In block 1014, the translation service 166 may cause a representation of a foreground communication to be output at least as sound from at least one of a first speaker element and a second speaker element. A “foreground communication” may be an electronic communication obtained by the translation service 166 while the translation device 102a is operating in a foreground-listening mode. In some embodiments, a foreground communication may include an audio representation of human speech (e.g., captured on one or more microphones of the translation device 102a, as described) or/or may include a textual representation of human speech (e.g., received via a user interface of the host device 106 and/or via a communication from another computing device). By way of a non-limiting example, the translation service 166 may cause the translation device 102a to output a first representation of the foreground communication in a first spoken language via a first speaker element and to output a second representation of the foreground communication in a second spoken language via a second speaker element. Some additional or alternative embodiments of the operations performed in block 1014 are described further herein (e.g., with reference to FIG. 11). The translation service 166 may continue performing operations of the routine 1000 in determination block 1024 as further described herein.

In response to determining that a foreground event has not occurred (i.e., determination block 1004=“NO”), the translation service 166 may determine whether a shared-listening event has occurred in determination block 1006. In some embodiments, the translation service 166 may determine that a shared-listening event has occurred in response to determining that a user input has been received on the host device 106 (e.g., on a user interface as further described at least with reference to FIG. 13). In such embodiments, the user input may be a selection of an interactive element included on a user interface that is associated with a shared-listening mode (e.g., a selectable icon representing a shared-listening mode). In some alternative or additional embodiments, the translation service 166 may determine that a shared-listening event has occurred in response to determining that a user input has been received on the translation device 102a (e.g., as detected by a touch sensor of a touch plate 214, as described at least with reference to FIGS. 2A-2B).

In some embodiments, the translation service 166 may determine that a shared-listening event has occurred in response to receiving a communication from at least one of the first translation device 102a and the second translation device 102b indicating that the first and second translation devices 102a, 102b have been coupled together (e.g., as depicted and described with reference to FIGS. 3A-3B). By way of a non-limiting example, one or more sensors included in the first and/or second translation devices 102a, 102b may be configured to detect that the first and second translation devices 102a, 102b are coupled together (e.g., Hall-effect sensors, proximity sensors, or the like). The first and/or second translation devices 102a, 102b may communicate information to the speech translation service 166 indicating the coupled state of the translation devices 102a, 102b, and in response, the speech translation service 166 may determine that a shared-listening event has occurred.

In some further embodiments, the translation service 166 may determine that a shared event has occurred in response to determining both that a user selection of a shared-listening mode has been received on a user interface of the host device 106 and that a user input has been received on the translation device 102a. In such embodiments, the selection of a shared-listening mode on the user interface of the host device 106 may identify an operational mode that the translation service 166 will cause the translation device 102a to transition to while operating in a background-listening mode; however, the translation service 166 may determine that a shared-listening event has occurred only in response to also determining that a user input is received on (and in some embodiments, only while such input is continued to be received on) the translation device 102a. In some embodiments, while a user input is not received on the translation device 102a, the translation service 166 may not determine that a shared-listening event has occurred, and the translation device 102a may instead continue operating in a background-listening mode. Accordingly, when a user input is received on the translation device 102a (e.g., when a user taps the touch plate 214 of the translation device 102a), the translation device 102a may provide a notification of the user input received on the translation device 102a to the translation service 166, and in response, the translation service 166 may determine that a shared event has occurred, thereby implementing an on-demand or “push-to-translate” shared-listening experience for a user.

In response to determining that a shared-listening event has occurred (i.e., determination block 1006=“YES”), the translation service 166 may cause the translation device to transition to a shared-listening mode from a background-listening mode, in block 1016. In some embodiments, the translation service 166 may cause the translation device to transition to a shared-listening mode at least in part by sending a communication to a processing unit 240 on the translation device 102a instructing the processing unit 240 to activate at least one omnidirectional microphone configured not to implement beamforming techniques. In such embodiments, the processing unit 240 may activate the at least one omnidirectional microphone by causing the at least one omnidirectional microphone to transition from a standby, low-power state to a high-power, active state suitable for capturing and processing sound. In some additional embodiments, the processing unit 240 may deactivate one or more other microphones while the translation device 102a is operating in the shared-listening mode, for example, by causing those one or more microphones to transition to a standby, low-power state from an high-power, active state and/or by discarding audio data generated using such one or more microphones without utilizing the audio data.

In block 1018, the translation service 166 may cause a representation of a shared communication to be output at least as sound from a second speaker element. In some embodiments, a “shared communication” may be an electronic communication obtained by the translation service 166 while the translation device 102a is operating in a shared-listening mode. In such embodiments, the shared communication may include an audio representation of human speech (e.g., captured on one or more microphones of the translation device 102a, as described) or/or include a textual representation of human speech (e.g., received via a user interface of the host device 106 and/or via a communication from another computing device). In some embodiments, the translation service 166 may cause the translation device 102a to output a representation of the shared communication in a first spoken language or a second spoken language via a second speaker element, or via a second speaker element and a first speaker element together. Some additional or alternative embodiments of the operations performed in block 1014 are described further herein (e.g., with reference to FIG. 11). The translation service 166 may continue performing operations of the routine 1000 in determination block 1024 as further described herein.

In response to determining that a shared-listening event has not occurred (i.e., determination block 1006=“NO”), the translation service 166 may determine whether a personal-listening event has occurred in determination block 1007. In some embodiments, the translation service 166 may determine that a personal-listening event has occurred in response to determining that a user input has been received on the host device 106 (e.g., on a user interface as further described at least with reference to FIG. 13). In such embodiments, the user input may be a selection of a personal-listening mode. In some alternative or additional embodiments, the translation service 166 may determine that a personal-listening event has occurred in response to determining that a user input has been received on the translation device 102a (e.g., as detected by a touch sensor of a touch plate 214, as described at least with reference to FIGS. 2A-2B).

In some further embodiments, the translation service 166 may determine that a personal event has occurred in response to determining both that a user selection of a personal-listening mode has been received on a user interface of the host device 106 and that a user input has been received on the translation device 102a. In such embodiments, the selection of a personal-listening mode on the user interface of the host device 106 may identify an operational mode that the translation service 166 will cause the translation device 102a to transition to while operating in a background-listening mode; however, the translation service 166 may determine that a personal-listening event has occurred only in response to also determining that a user input is received on (and in some embodiments, only while such input is continued to be received on) the translation device 102a. In some embodiments, while a user input is not received on the translation device 102a, the translation service 166 may not determine that a personal-listening event has occurred, and the translation device 102a may instead continue operating in a background-listening mode. Accordingly, when a user input is received on the translation device 102a (e.g., when a user taps the touch plate 214 of the translation device 102a), the translation device 102a may provide a notification of the user input received on the translation device 102a to the translation service 166, and in response, the translation service 166 may determine that a personal event has occurred, thereby implementing an on-demand or “push-to-translate” personal-listening experience for a user.

In response to determining that a personal-listening event has occurred (i.e., determination block 1007=“YES”), the translation service 166 may cause the translation device to transition to a personal-listening mode from a background-listening mode, in block 1020.

In some embodiments, the translation service 166 may cause the translation device to translation to a personal-listening mode at least in part by sending a communication to a processing unit 240 on the translation device 102a instructing the processing unit 240 to activate at least one directional microphone and/or a plurality of omnidirectional microphones configured to implement beamforming techniques. In such embodiments, the processing unit 240 may activate the at least one direction microphone and/or the plurality of omnidirectional microphones by causing such microphones to transition from a standby, low-power state to a high-power, active state suitable for capturing sound. In some additional embodiments, the processing unit 240 may deactivate one or more other microphones while the translation device 102a is operating in the personal-listening mode, for example, by causing those one or more microphones to transition to a standby, low-power state from an high-power, active state and/or by discarding audio data generated using such one or more microphones without utilizing the audio data.

In block 1022, the translation service 166 may cause a representation of a personal-listening communication to be output at least as sound from a first speaker element. A “personal communication” may be an electronic communication obtained by the translation service 166 while the translation device 102a is operating in a personal-listening mode. In some embodiments, a personal communication may include an audio representation of human speech (e.g., captured on one or more microphones of the translation device 102a, as described) or/or may include a textual representation of human speech (e.g., received via a user interface of the host device 106 and/or via a communication from another computing device). By way of a non-limiting example, the translation service 166 may cause the translation device 102a to output a representation of the personal communication in a second spoken language via a first speaker element. Some additional or alternative embodiments of the operations performed in block 1014 are described further herein (e.g., with reference to FIG. 11). The translation service 166 may continue performing operations of the routine 1000 in determination block 1024 as further described herein. In determination block 1026, the translation service 166 may determine whether to continue operating in a personal-listening mode 1026.

In response to determining to continue operating in a personal-listening mode (i.e., determination block 1026=“YES”), the translation service 166 may perform the above operations in a loop starting in block 1022 by causing a representation of another personal-listening communication to be output at least as sound form a first speaker element. In some embodiments, the translation service 166 may continue performing the operations in block 1022 and determination block 1026 until the translation service 166 determines not to continue operating in a personal-listening mode. In response to determining not to continue operating in a personal-listening mode (i.e., determination block 1026=“NO”), the translation service 166 may continue performing operations of the routine 1000 in determination block 1024 as further described herein.

In response to determining that a background communication has been received (i.e., determination block 1008=“YES”), the translation service 166 may cause a representation of the background communication to be generated in a first spoken language and output at least as sound from a first speaker element. A “background communication” may be an electronic communication obtained by the translation service 166 while the translation device 102a is operating in a background-listening mode. In some embodiments, a background communication may include an audio representation of human speech (e.g., captured on one or more microphones of the translation device 102a, as described) or/or may include a textual representation of human speech (e.g., received via a user interface of the host device 106 and/or via a communication from another computing device). By way of a non-limiting example, the translation service 166 may cause the translation device 102a to output a representation of the background communication in a first spoken language via a first speaker element. The translation service 166 may continue performing operations of the routine 1000 in determination block 1024 as further described herein.

In determination block 1024, the translation service 166 may determine whether to continue translation services. In some embodiments, the translation service 166 may continue providing translation services until the translation service 166 receives (directly or indirectly) a user input indicating that the translation services should be terminated. In response to determining to continue translation services (i.e., determination block 1024=“YES”), the translation service 166 may repeat the above operations starting in block 1002, for example, by causing the translation device to enter a background-listening mode if not already operating in a background-listening mode. In response to determining to end the translation services (i.e., determination block 1024=“NO”), the translation service 166 may cease performing the routine 1000.

FIG. 11 is a flow diagram of an illustrative subroutine 1014a for causing a representation of a foreground communication to be output, according to some embodiments. In some embodiments, the subroutine 1014a may be implemented by a translation service operating on a translation device (e.g., the translation service 166 of the translation device 102 as described with reference to FIG. 1B). In some embodiments, the operations of the subroutine 1014a may implement embodiments of the operations described with reference to block 1014 in the routine 1000. Thus, in such embodiments, the translation service 166 may begin performing the subroutine 1014a in response to causing the translation device to transition to a foreground-listening mode in block 1012 of the routine 1000.

With reference to FIG. 11, the translation service 166 may determine, in determination block 1102, whether a foreground communication has been received. In some embodiments of the operations performed in block 1102, the translation service 166 may determine that a foreground communication has been received in response to receiving audio from at least the translation device 102a, in which the data includes an audio representation of human speech. In some embodiments, the translation service 166 may determine that a foreground communication has been received in response to receiving data (e.g., from another computing device or from a user interface of the host device 106) that includes a textual (or audio) representation of human speech.

In response to determining that a foreground communication has been received (i.e., determination block 1102=“YES”), the translation service 166 may optionally determine whether the foreground communication originated from a user of the translation device, in optional determination block 1104. In some embodiments, the translation service 166 may perform one or more speaker identification techniques (as would be known by one skilled in the art) to determine whether an audio representation of human speech matches speaking patterns associated with a user of the translation device. By way of a non-limiting example, the translation service 166 may maintain a speaker profile for a user of the translation device 102a and/or the host device 106. In response to receiving an audio representation of human speech from the translation device 102a, the translation service 166 may attempt to match the audio representation with the speaker profile of the user. If there is a sufficient match (e.g., within a threshold confidence), the translation service 166 may determine that the foreground communication originated from the user of the translation device 102a. In some embodiments, the translation service 166 may determine that the foreground communication that includes a textual representation of human speech originated from a user of the translation device 102a in the event that the foreground communication was received via a user interface included on the host device 106 (e.g., input as text by a user). In some embodiments, the translation service 166 may determine that a foreground communication originated from a user of the translation device in response to determining that a spoken language of human speech included in the foreground communication is associated with the user.

In response to determining that the foreground communication did not originate from a user of the translation device (i.e., optional determination block 1104=“NO”), the translation service 166 may optionally cause a representation of the foreground communication in a first spoken language to be output as sound from a first speaker element, in optional block 1106. In some embodiments, the translation service 166 may identify a spoken language of human speech included in the foreground communication obtained by the translation service 166. The translation service 166 may (directly or in conjunction with one or more other computing devices, such as the network computing device 116) translate the human speech included in the foreground communication into a first spoken language associated with a user of the translation device 102a. For example, the foreground communication may have included a representation of human speech in Spanish, and the translation service 166 may (directly or indirectly) cause the human speech to be translated into English. The translation service 166 may then cause the translated speech to be provided to the translation device 102a and output as sound from a first speaker in the first translation device 102a.

In response to determining that a foreground communication has been received (i.e., determination block 1102=“YES”) or, optionally, in response to determining that the foreground communication originated from a user of the translation device (i.e., optional determination block 1104=“YES”), the translation service 166 may cause a representation of the foreground communication in a second spoken language to be output as sound from a second speaker element, in block 1110. In some embodiments, the translation service 166 may identify a spoken language of human speech included in the foreground communication obtained by the translation service 166. The translation service 166 may (directly or in conjunction with one or more other computing devices, such as the network computing device 116) translate the human speech included in the foreground communication into a second spoken language (e.g., based at least in part on a user setting defining the second spoken language). For example, the foreground communication may have included a representation of human speech in English, and the translation service 166 may (directly or indirectly) cause the human speech to be translated into Spanish. The translation service 166 may then cause the translated speech to be provided to the translation device 102a and output as sound from a second speaker in the first translation device 102a.

In block 1112, the translation service 166 may cause a representation of the foreground communication in a first spoken language to be output as sound from a first speaker element. In some embodiments, the translation service 166 may (directly or in conjunction with one or more other computing devices, such as the network computing device 116) translate the human speech included in the foreground communication into a first spoken language (e.g., based at least in part on a user setting defining the second spoken language). For example, the foreground communication may have included a representation of human speech in English, and the translation service 166 may (directly or indirectly) cause the human speech to be translated back into English. Specifically, the translation service 166 may translate the human speech included in the foreground communication into the same language in order to enable a user of the translation device 102a to determine whether the foreground communication was unintentionally mistranslated. The translation service 166 may then cause the translated speech to be provided to the translation device 102a and output as sound from a first speaker in the first translation device 102a.

In response to determining that a foreground communication has not been received (i.e., determination block 1102=“NO”), causing a representation of the foreground communication in a first spoken language to be output as sound from a first speaker element (i.e., block 1106), or causing a representation of the foreground communication in a first spoken language to be output as sound from a first speaker element (i.e., block 1112), the translation service 166 may determine whether to continue operating in a foreground-listening mode, in determination block 1108. In some embodiments, the translation service 166 may continue providing translation services until the translation service 166 receives (directly or indirectly) a user input indicating that the translation services should be terminated. In some embodiments, the translation service 166 may continue operating in a foreground-listening mode for a predetermined period of time or until a predetermined number of foreground communications have been received. In response to determining to continue operating in a foreground-listening mode (i.e., determination block 1108=“YES”), the translation service 166 may repeat the above operations starting in determining block 1102, for example, by again determining whether a foreground communication has been received. In response to determining to cease operating in a foreground-listening mode (i.e., determination block 1108=“NO”), the translation service 166 may cease performing the operations of the subroutine 1014a and may return to performing operations of the routine 1000, such as by determining whether to continue providing translation services, in determination block 1024.

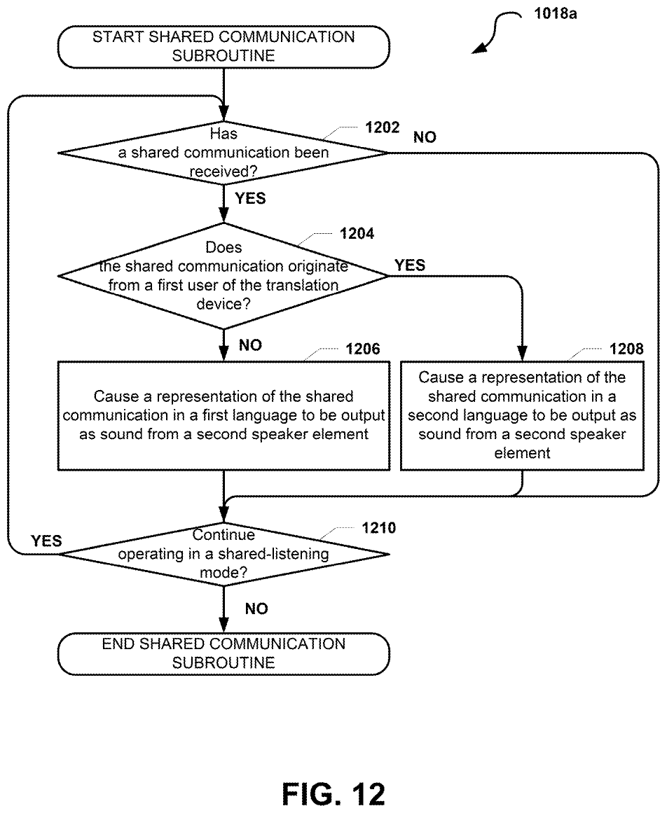

FIG. 12 is a flow diagram of an illustrative subroutine 1018a for causing a representation of a shared communication to be output at least as sound from a second speaker element, of from a second speaker element and a first speaker element together, according to some embodiments. In some embodiments, the subroutine 1018a may be implemented by a translation service operating on a translation device (e.g., the translation service 166 of the translation device 102 as described with reference to FIG. 1B). In some embodiments, the operations of the subroutine 1018a may implement embodiments of the operations described with reference to block 1018 in the routine 1000. Thus, in such embodiments, the translation service 166 may begin performing the subroutine 1018a in response to causing the translation device to transition to a shared-listening mode in block 1016 of the routine 1000.

In determination block 1202, the translation service 166 may determine whether a shared communication has been received. In some embodiments of the operations performed in block 1202, the translation service 166 may determine that a shared communication has been received in response to receiving audio from at least the translation device 102a, in which the data includes an audio representation of human speech. In some embodiments, the translation service 166 may determine that a shared communication has been received in response to receiving data (e.g., from another computing device or from a user interface of the host device 106) that includes a textual (or audio) representation of human speech.

In response to determining that a shared communication has been received (i.e., determination block 1202=“YES”), the translation service 166 may determine whether the shared communication originated from a first user of the translation device. In some embodiments, the translation service 166 may perform one or more speaker identification techniques (as would be known by one skilled in the art) to determine whether an audio representation of human speech matches speaking patterns associated with a first user of the translation device or another user of the translation device. By way of a non-limiting example, the translation service 166 may maintain a speaker profile for the first user of the translation device 102a and/or the host device 106. In response to receiving an audio representation of human speech from the translation device 102a, the translation service 166 may attempt to match the audio representation with the speaker profile of the first user. If there is a sufficient match (e.g., within a threshold confidence), the translation service 166 may determine that the shared communication originated from the first user of the translation device 102a. In some embodiments, the translation service 166 may determine that the shared communication that includes a textual representation of human speech originated from the first user of the translation device 102a in the event that the shared communication was received via a user interface included on the host device 106 (e.g., input as text by a user). In some embodiments, the translation service 166 may determine that a shared communication originated from the first user of the translation device in response to determining that a spoken language of human speech included in the shared communication is associated with the first user.

In some embodiments, the translation service 166 may determine that the shared communication originated from a first user in response to determining that a user input was received on the first translation device 102a in conjunction with the shared communication. For example, a touch input and the shared communication may have been received near in time by the first translation device 102a. Similarly, the translation service 166 may determine that the shared communication originated from a second user in response to determining that a user input was received on the second translation device 102b in conjunction with the shared communication. In such embodiments, a first user associated with a first spoken language may utilize the first translation device 102a to have shared communications translated into a second spoken language. Similarly, a second user associated with a second spoken language may utilize the second translation device 102b to have shared communications translated into a first spoken language.

In response to determining that the shared communication originated from a user of the translation device (i.e., determination block 1204=YES″), the translation service 166b may cause a representation of the shared communication in a second spoken language to be output as sound from a second speaker (e.g., included in first and/or second translation devices 102a, 102b), or from a second speaker and a first speaker together. In some embodiments, the translation service 166 may identify a spoken language of human speech included in the shared communication obtained by the translation service 166. The translation service 166 may (directly or in conjunction with one or more other computing devices, such as the network computing device 116) translate the human speech included in the shared communication into a second spoken language. For example, the shared communication may have included a representation of human speech in English, and the translation service 166 may (directly or indirectly) cause the human speech to be translated into Spanish. The translation service 166 may then cause the translated speech to be provided to the translation device 102a and output as sound from a second speaker (e.g., in the first translation device 102a or the second translation device 102b).

In response to determining that the shared communication did not originate from a first user of the translation device (i.e., determination bock 1204=“NO”), the translation service 166 may cause a representation of the shared communication in a first spoken language to be output as sound from a second speaker element, or from a second speaker and a first speaker together. In some embodiments, the translation service 166 may identify a spoken language of human speech included in the shared communication obtained by the translation service 166. The translation service 166 may (directly or in conjunction with one or more other computing devices, such as the network computing device 116) translate the human speech included in the shared communication into a first spoken language. For example, the foreground communication may have included a representation of human speech in Spanish, and the translation service 166 may (directly or indirectly) cause the human speech to be translated into English. The translation service 166 may then cause the translated speech to be provided to the translation device 102a and output as sound from a second speaker (e.g., in the first translation device 102a or the second translation device 102b), or from a second speaker and a first speaker together.

In response to determining that a shared communication has not been received (i.e., determination block 1202=“NO”), causing a representation of the shared communication in the first spoken language to be output as sound from a second speaker in block 1206, or causing a representation of the shared communication in a second spoken language to be output as sound from a second speaker element (or from a second speaker and a first speaker together) in block 1208, the translation service 166 may determine whether to continue operating in a shared-listening mode, in determination block 1210. In some embodiments, the translation service 166 may continue having at least the translation device 102a operate in the shared-listening mode until the translation service 166 receives (directly or indirectly) a user input indicating that at least the first translation device 102a should no longer operate in the shared-listening mode. In some embodiments, the translation service 166 may continue operating in a shared-listening mode for a predetermined period of time or until a predetermined number of shared communications have been received. In response to determining to continue operating in a shared-listening mode (i.e., determination block 1210=“YES”), the translation service 166 may repeat the above operations starting in determining block 1202, for example, by again determining whether a shared communication has been received. In response to determining to cease operating in a shared-listening mode (i.e., determination block 1210=“NO”), the translation service 166 may cease performing the operations of the subroutine 1018a and may return to performing operations of the routine 1000, such as by determining whether to continue providing translation services, in determination block 1024.

FIG. 13 is a diagram depicting an illustrative user interface 1300 included in the host device 106, according to some embodiments. In some embodiments, the user interface 1300 may be displayed on a touch-sensitive display 1301 included in the host device 106 in communication with at least a first translation device 102a (e.g., as generally described with reference to at least FIG. 1B). In such embodiments, the user interface 1300 may provide visual information to a user and may receive user inputs, for example, as further described herein.

The user interface 1300 may include one or more interactive elements that receive input or display information. In the example illustrated in FIG. 13, the user interface 1300 may include an interactive element 1302 that may identify a language that is currently selected as a first spoken language (e.g., as described generally above). Similarly, an interactive element 1304 may identify a language that is currently selected as a second spoken language. In response to receiving a user input on the interactive element 1302, the user interface 1300 may display a list of one or more language (not shown). In response to receiving a user input that selects on of the language included in the list of language, the interactive element 1302 may be updated to display the selected language. In such embodiments, audio data including human speech received from a translation device (e.g., as described with reference to at least FIGS. 4A-12) may be presumed to be the language indicated by the interactive element 1302, and the human speech included in such audio data may be translated into a language indicated by the interactive element 1304.

The user interface 1300 may include an area in which textual transcriptions and translations of human speech are displayed (e.g., in a display area 1311 bounded by dotted lines as illustrated in FIG. 13). In some embodiments, the display area 1311 may include interactive elements corresponding to textual transcriptions and translations of human speech and aligned according to a language of the utterance that was initially received. In the example illustrated in FIG. 13, an interactive element 1308 may present a textual translation of audio data including human speech in Spanish and may be aligned with the interactive element 1304 to the right side of the display area 1311, an interactive element 1310 may present a textual translation of audio data including human speech in English and may be aligned with the interactive element 1302 to the left side of the display 1311. Specifically, the interactive element 1308 may present visually, in a first spoken language, a textual transcription of human speech in a second spoken language included in audio data. In some embodiments, interactive elements included in the display area may include a transcription of speech in both first and second spoken languages. In some additional (or alternative) embodiments, interactive elements included in the display area may be selected via a user input. Once selected, such interactive elements may cause the first translation device 102a and/or the second translation device 102b to replay an audio output associated with such interactive elements. By way of a non-limiting example, the interactive element 1310 may be associated with an English input phrase of “Sure do! What time?” In response to receiving a user input on the interactive element 1310, the host device 106 may cause the first translation device 102a and/or the second translation device 102b to play out a translated, Spanish version of that phrase (e.g., “ [symbol] Seguro hazlo! ¿Que Nora?”).

In some embodiments, the user interface 1300 may include one or more interactive elements that may be used to cause the first translation device 102a and/or the second translation device 102b to operate in one or more modes. By way of a non-limiting example, an interactive element 1314 may correspond to a personal-listening mode such that, when the interactive element 1314 is selected via a user input, the host computing device 106 may provide the first translation device 102a and/or the second translation device 102b with instructions/commands that may cause the first translation device 102a and/or the second translation device 102b to begin operating in a personal-listening mode (e.g., as described at least with reference to FIGS. 5A-5B). When an interactive element 1316 is selected (e.g., via a user touch input), the speech translation service 166 may provide the first translation device 102a and/or the second translation device 102b with instructions/commands that may cause the first translation device 102a and/or the second translation device 102b to begin operating in a foreground-listening mode (e.g., as described at least with reference to FIGS. 6A-7B). When an interactive element 1318 is selected (e.g., via a user touch input), the speech translation service 166 may provide the first translation device 102a and/or the second translation device 102b with instructions/commands that may cause the first translation device 102a and/or the second translation device 102b to begin operating in a shared-listening mode (e.g., as described at least with reference to FIGS. 8A-9B).

In some embodiments (not shown), the user interface display 1311 may include an interactive element. When such interactive element is selected (e.g., via a user touch input), the speech translation service 166 may provide the first translation device 102a and/or the second translation device 102b with instructions/commands that may cause the first translation device 102a and/or the second translation device 102b to begin operating in a background-listening mode (e.g., as described at least with reference to FIGS. 4A-4B).

In some alternative (or additional) embodiments, while the interactive element 1314 is selected, the speech translation service 166 may provide the first translation device 102a and/or the second translation device 102b with instructions/commands that may cause the first translation device 102a and/or the second translation device 102b to operate in a background-listening mode until a user input is received on the first translation device 102a and/or the second translation device 102b, at which point, the first translation device 102a and/or the second translation device 102b may begin operating in a personal-listening mode. By way of a non-limiting example, a user of the first translation device 102a may select the interactive element 1314 so that the first translation device 102a operates in a background-listening mode until the user taps the first translation device 102a. In response to that tap, the first translation device 102a may transition to the personal listening device, which may be suitable for capture speech from the user.

In some alternative (or additional) embodiments, while the interactive element 1316 is selected, the speech translation service 166 may provide the first translation device 102a and/or the second translation device 102b with instructions/commands that may cause the first translation device 102a and/or the second translation device 102b to operate in a background-listening mode until a user input is received on the first translation device 102a and/or the second translation device 102b, at which point, the first translation device 102a and/or the second translation device 102b may begin operating in a foreground-listening mode. By way of a non-limiting example, a user of the first translation device 102a may select the interactive element 1314 so that the first translation device 102a operates in a background-listening mode until the user taps the first translation device 102a. In response to that tap, the first translation device 102a may transition to the personal listening device, which may be suitable for capture speech from the user.

In some embodiments, the user interface 1311 may include an interactive element 1312. The interactive element 1312 may be an input interface (e.g., a text box or the like) that receive a textual input (e.g., via a virtual keyboard (not shown)). In response to receiving the textual input on the interactive element 1312, the speech translation service 166 may cause the textual input to be used to generate audio data including a representation of the text in at least one of a first or second spoken language. Specifically, in the event that the interactive element 1316 is selected, the speech translation service 166 may cause the text input to be converted into an audio data including an audio representation of the text in a first spoken language and an audio representation of the text in a second spoken language. The speech translation service 166 may cause the audio data to be provided to the first and/or second translation devices 102a, 102b, which may be caused to operate in the foreground-listening mode and output the audio data via first and second speakers on each of the first and second translation devices 102a, 102b (e.g., as described with reference to FIGS. 6A-6B). In the event that the interactive element 1314 selected, the speech translation service 166 may cause the text input to be converted into an audio data including an audio representation of the text in a second spoken language. The speech translation service 166 may cause the audio data to be provided to the first and/or second translation devices 102a, 102b, which may be caused to operate in the personal-listening mode and output the audio data via a first speaker on the first and/or second translation devices 102a, 102b (e.g., as described with reference to FIGS. 5A-5B).

In some embodiments (not shown), while the interactive element 1318 is selected, the display area 1311 may display a prompt indicating which of the first spoken language (e.g., as represented by the interactive element 1302) or the second spoken language (e.g., as represented by the interactive element 1304) is expected to be received. By way of a non-limiting example, the prompt may display “Waiting for input in English . . . ” or “Waiting for input in Spanish . . . ” depending on the language that was last received. In such example, the prompt may change to indicate Spanish language is expected after receiving English speech, and vice versa.

In some embodiments, a translation system may be configured to create and operate a translation group among a plurality of host devices. Specifically, the translation system may facilitate transmission and translation of communications between host devices, where each host device is associated with a particular language. In such embodiments, the network computing device may receive a message from a host device in a first spoken language (e.g., English). The network computing device 116 may translate the message from the first spoken language into one or more other spoken languages (e.g., Spanish, French, and the like) associated with other host devices in the translation group and may provide those host devices with the translated messages.

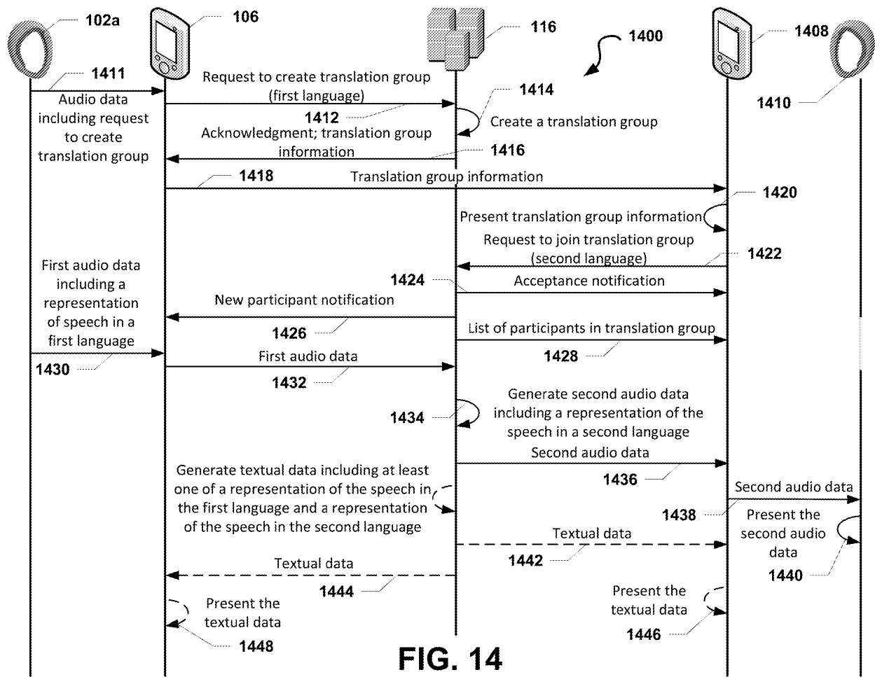

FIG. 14 is a signal and call flow diagram that illustrates a translation system 1400 suitable for implementing a translation group, according to some embodiments. The system 1400 may include the first translation device 102a (e.g., as described at least with reference to one or more of the FIGS. 1A-13), the host device 106 (e.g., as described at least with reference to one or more of the FIGS. 1A-1B, 4-13), the network computing device 116 (e.g., as described at least with reference to FIG. 1A), a host device 1408, and a translation device 1410. In some embodiments, the host device 1408 may be configured similarly to the host device 106 as described in various embodiments. The translation device 1410 may be configured similarly to the translation device 102a according to various embodiments.

In some embodiments, the host device 102a may be in communication with the host device 106. The host device may be in communication with the network computing device 116 and the host device 1408 (e.g., via a Bluetooth, WiFi Direct, or another wireless communication protocol). The translation device 1410 may be in communication with the host device 1408. The host device 1408 may be in communication with the network computing device 116.

In the example illustrated in FIG. 14, the translation device 102a may capture a voice command to create a translation group from a user, and the translation device 102a may transmit a message 1411 including audio data including the request to create a translation group to the host device 106. The host device 106 may send a communication 1412 to the network computing device 116 that includes the request to create a translation group, an identification of the host device 106, and an indication of a first spoken language to be associated with the host device.

In response to receiving the communication 1412, the network computing device 116 may create a translation group in operation 1414. In some embodiments, the network computing device 116 may create a translation group by generating an initially empty data set that includes a list of hosting devices (or other devices) and their associated languages. The network computing device 116 may then include the host device 106's identification in the translation group and associate the host device 106 with the first spoken language. The network computing device 116 may also generate a translation group ID to identify the set of host devices associated with the translation group. The network computing device 116 may provide an acknowledgement and information regarding the translation group to the host device 106, via a communication 1416. In some embodiments, the information regarding the translation group may include at least the translation group ID.

In some embodiments, the host computing device 106 may provide the translation group information to the host device 1408, via a communication 1418. Specifically, the host computing device 106 may share information about the translation group that may enable the host device 1408 to join the translation group. In response to receiving the translation group information, the host device 1408 may present the translation group information in operation 1420, for example, on a display included on the host device 1408.

In some embodiments, the host device 1408 may receive a user input (not shown) that causes the host device 1408 to send a communication 1422 to the network computing device 116 requesting to join the translation group. In such embodiments, the communication may include at least identifying information of the host device 1408, the translation group information, and an indication that the host device is associated with a second spoken language. In response to receiving the communication 1422, the network computing device 116 may add the host device 1408 to the translation group and provide an acceptance notification 1424 to the host device 1408. The network computing device 116 may also provide a notification to the host device 106 indicating that a new participant has joined the translation group. In some embodiments, the notification 1424 may indicate information regarding the host device 1408, such as identifying information regarding the host device 1408, a user of the host device 1408 (as provided to the network computing device 116 from the host device 1408), a second spoken language associated with the host device 1408, and the like. The network computing device 116 may provide the host device 1408 with a list of participants in the translation group, via a communication 1428. In some embodiments (not shown), the host device 1408 may present at least a portion of the information regarding the list of participants in the translation group, for example, on a display of the host device 1408.

Continuing with the example illustrated in FIG. 14, the translation device 102a may provide the host device 106 with first audio data include a representation of speech in a first spoken language (e.g., via a wireless communication). As described, the translation device 102a may include one or more microphones configured to capture human speech, and the translation device 102a may provide the host device 106 with audio data representing that human speech. In some embodiments, the host device may pass along the first audio data to the network computing device 116, via a communication 1432.

In some embodiments the network computing device 116 may, in response to receiving the first audio data, generate audio data including a representation of the speech in a language for each other hosting device included in the translation group. Accordingly, the network computing device 116 may generate second audio data including a representation of the speech in a second spoken language, in operation 1434. The network computing device 116 may then provide the second audio data to the hosting device 1408, via communication 1436. In response to receiving the second audio data, the host device 1408 may provide the second audio data to the translation device 1410 (e.g., via communication 1438), which may then present the second audio data in operation 1440, for example, by playing out the second audio data as sound via one or more speakers (e.g., as generally described above).

In some optional embodiments, the network computing device 116 may generate textual data that includes a representation of the human speech included in the first audio in both a first spoken language and a second spoken language, which may function as a transcription of the translated conversation. The network computing device 116 may provide the textual data to the host 1408 (e.g., via optional communication 1442) and to the host 102a (e.g., via optional communication 1444). In response to receiving the textual information, the host device 1446 may present the textual data (e.g., in optional operation 1446), for example, on a display included on or in communication with the hosting device 1408. Similarly, the translation device 102a may present the textual data (e.g., in optional operation 1448).

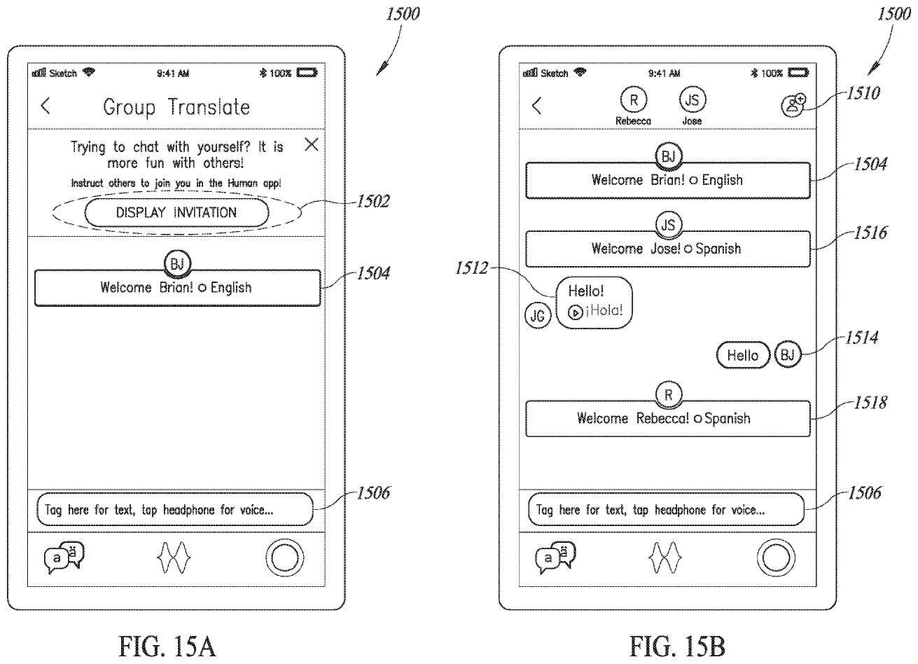

FIGS. 15A-15B is a diagram depicting an illustrative user interface 1500 that may be displayed on a host device (e.g., the host device 106), according to some embodiments. In some embodiments, the user interface 1500 may be displayed on a touch-sensitive display included in the host device 106 in communication with at least a first translation device 102a (e.g., as generally described with reference to at least FIG. 1B). In such embodiments, the user interface 1500 may provide visual information to a user and may receive user inputs, for example, as further described herein.

The user interface 1500 may include one or more interactive elements that receive input or display information. In the example illustrated in FIG. 15A, the user interface 1500 may include an interactive element 1502 that may display information regarding a translation group, such as a code or other information required to join the translation group. The user interface 1500 may also include an interactive element 1504 displaying information regarding the user and/or host device hosting the user interface 1500. In some embodiments, the user interface 1500 may include an interactive element 1506 that may be configured to receive textual input that may be provided to a network computing device in order to enable the network computing device to provide a translated version of the textual input to other devices in the translation group.

FIG. 15B illustrates an example of the user interface 1500 once another user has joined the translation group. Specifically, once another user has joined the translation group, the network computing device may provide an indication that may be displayed as an interactive element 1516 and 1518. The user interface 1500 may further present textual transcripts of audio or textual data that has been exchanged and translated between different users (e.g., as described generally with reference to FIG. 14). In the example illustrated in FIG. 15B, transcriptions of exchanges between users may be presented as the interactive elements 1512, 1514.

Various references to a language being a “first spoken language” or a “second spoken language” are merely for ease of description and, unless provided for in the claims, are not meant to require a language to be a “first” or “second” language. Specifically, a “first spoken language” at one time may be a “second spoken language” at another time, and vice versa. In some instances, a first spoken language may be different from a second spoken language (e.g., English as a first spoken language and Spanish as a second spoken language). However, in some other instances, the first and second spoken languages may be the same such that the language of the translated representation is the same language as the initial representation included in the sound captured via one or more microphones of the first translation device 102a. In some embodiments, the speech translation service 166 may cause the first translation device 102a to output sound that includes a translated representation of human speech only in the event that the first and second spoken languages are different. In alternative embodiments, the speech translation service 166 may cause the first translation device 102a to output sound that includes a translated representation of human speech regardless of whether the first and second spoken languages are the same or different.

While descriptions of embodiments refer to a user wearing one or more translation devices, in some embodiments, the user need not wear the one or more translation devices. For example, a first user may don a first translation device on the first user's ear, and a second translation device may be held in the hand of a second user. In this example, the second translation device may play out audio data (e.g., including translated human speech in a second spoken language) using a loud speaker that may be audible to individuals in close proximity to the second translation device. Further, the first translation device may play out audio data (e.g., including translated human speech in a first spoken language) using speaker suitable for use in an earphone or a headphone (e.g., a personal-listening speaker).

In some embodiments, a translation device (or another device in a speech translation system, for example, as described with reference to FIG. 1A) may obtain audio data of human speech, and the translation devices may temporarily store a certain amount of audio data, for example, in a buffer. By way of a non-limiting example, the translation device may continuously or continually store the last n seconds of audio obtained on the translation device. In some embodiments, the translation device may obtain a user input (e.g., a touch input, a speech or voice command, etc.), and in response, the translation device may permanently store the audio stored in the buffer. For example, the translation device may store 10 seconds of audio data in the buffer, and the translation device may continuously overwrite the oldest audio data in the buffer as new audio data is obtained. In response to receiving the voice command (e.g., the phrase “save that” or “bookmark that”), the translation device may move the audio data in the buffer to a permanent memory location.

In some embodiments, the translation device may receive user input (e.g., touch inputs or voice commands) that may start and stop translation services or may adjust setting for the translation services. For example, the translation device may receive a touch input, and the translation device may begin performing one or more of the translation operations described above in response. In this example, the translation device may receive another touch input, and the translation device may suspend or cease performing these translation operations in response.

In some embodiments, the translation device may begin, suspend, or cease operations based on characteristics of the audio data obtained. For example, the translation device may perform translation operations such as those described above while human speech is detected. In response to determining that human speech is not detected, the translation device may suspend performing those operations. Further, in response to determining that the human speech has not been detected for a threshold period of time (e.g., for two minutes), the translation device may cease performing the speech translation operations.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

This application claims the benefit of priority to U.S. Provisional Application No. 62/654,960, filed Apr. 9, 2018, which application is hereby incorporated by reference in its entirety.

What is claimed is:

1. A computer-implemented method, comprising:
causing a translation device that includes a first speaker element and a second speaker element to operate in a background-listening mode;
determining that a background communication has been received by the translation device;
causing a first representation of human speech in a first spoken language to be generated based at least in part on the background communication; and
causing the first representation of human speech to be output as sound via the first speaker element.

2. The computer-implemented method of claim 1, wherein causing the translation device to operate in a background-listening mode comprises causing an omnidirectional microphone included in the translation device to be configured to capture human speech.

3. The computer-implemented method of claim 2, wherein causing the omnidirectional microphone included in the translation device to be configured to capture human speech comprises causing the omnidirectional microphone to transition from a standby state to an active state.

4. The computer-implemented method of claim 1, wherein determining that a background communication has been received by the translation device comprises one of:
determining that an utterance has been captured by an omnidirectional microphone included on the translation device, wherein the utterance comprises human speech; or
determining that a textual message has been received, wherein the textual message comprises a textual representation of human speech.

5. The computer-implemented method of claim 1, wherein causing the first representation of human speech in the first spoken language to be generated comprises causing generation of a translation of human speech from a second spoken language to the first spoken language utilizing at least one of automatic speech recognition or spoken language understanding.

6. The computer-implemented method of claim 1, further comprising:
determining that a foreground event has occurred;
causing the translation device to operate in a foreground-listening mode;
determining that a foreground communication has been received by the translation device; and
causing, using the foreground communication, at least one representation of human speech to be output at least as sound from at least one of the first speaker element and the second speaker element.

7. The computer-implemented method of claim 6, wherein determining that a foreground event has occurred comprises at least one of:
determining that a user input has been received; and
determining that a foreground-listening mode setting has been selected.

8. The computer-implemented method of claim 6, wherein determining that a foreground communication has been received by the translation device comprises determining that an utterance has been captured by a plurality of omnidirectional microphones included on the translation device and configured to implement beamforming techniques.

9. The computer-implemented method of claim 6, wherein determining that a foreground communication has been received by the translation device comprises determining that an utterance has been captured by a directional microphone included on the translation device.

10. The computer-implemented method of claim 6, wherein causing, using the foreground communication, at least one representation of human speech to be output at least as sound from at least one of the first speaker element and the second speaker element comprises:
causing a second representation of human speech in a first spoken language to be generated based at least in part on the foreground communication;
causing a third representation of human speech in a second spoken language to be generated based at least in part on the foreground communication;
causing the second representation of human speech to be output as sound via the first speaker element; and
causing the third representation of human speech to be output as sound via the second speaker element.

11. The computer-implemented method of claim 1, further comprising:
determining that a shared-listening event has occurred;
causing the translation device to operate in a shared-listening mode;
determining that a shared communication has been received by the translation device; and
causing, using the shared-listening communication, at least one representation of human speech to be output at least as sound from the second speaker element.

12. The computer-implemented method of claim 11, wherein determining that a shared event has occurred comprises at least one of:
determining that a user input has been received;
determining that a shared-listening mode setting has been selected; and
determining that the translation device is coupled to another translation device.

13. The computer-implemented method of claim 11, wherein determining that a shared communication has been received by the translation device comprises determining that an utterance has been captured by at least one omnidirectional microphone included on the translation device.

14. The computer-implemented method of claim 11, wherein causing, using the shared communication, at least one representation of human speech to be output at least as sound from the second speaker element comprises:
determining a spoken language associated with the shared communication;
in response to determining that the spoken language associated with the shared communication is the first spoken language, causing a second representation of human speech in a second spoken language to be generated based at least in part on the shared communication;
in response to determining that the spoken language associated with the shared communication is the second spoken language, causing a third representation of human speech in the first spoken language to be generated based at least in part on the shared communication; and
causing one of the first representation of human speech or the second representation of human speech to be output as sound via the second speaker element.

15. The computer-implemented method of claim 14, wherein determining a spoken language associated with the shared communication comprises determining whether the shared communication originated from a user of the translation device.

16. The computer-implemented method of claim 1, further comprising:
determining that a personal-listening event has occurred;
causing the translation device to operate in a personal-listening mode;
determining that a personal-listening communication has been received by the translation device; and
causing, using the personal-listening communication, at least one representation of human speech to be output at least as sound from the first speaker element.

17. The computer-implemented method of claim 16, wherein determining that a personal-listening event has occurred comprises at least one of:
determining that a user input has been received; and
determining that a personal-listening mode setting has been selected.

18. The computer-implemented method of claim 16, wherein determining that a personal-listening communication has been received by the translation device comprises determining that an utterance has been captured by a plurality of omnidirectional microphones included on the translation device and configured to implement beamforming techniques.

19. The computer-implemented method of claim 16, wherein determining that a personal-listening communication has been received by the translation device comprises determining that an utterance has been captured by a directional microphone included on the translation device.

20. The computer-implemented method of claim 16, wherein causing, using the personal-listening communication, at least one representation of human speech to be output at least as sound from the first speaker element comprises:
causing a second representation of human speech in a second spoken language to be generated based at least in part on the personal-listening communication; and
causing the second representation of human speech to be output as sound via the first speaker element.

21. A computer-implemented method, comprising performing any of the methods recited in claims 1-20 by one or more or a combination of a translation device, a host device, and a network-computing device.

22. A non-transitory, computer-readable medium having stored thereon computer-executable software instructions configured to cause a processor of a computing device to perform steps of any method recited in claims 1-20.

23. A computing device, comprising:
a memory configured to store processor-executable instructions; and
a processor in communication with the memory and configured to execute the processor-executable instructions to perform operations comprising any of the methods recited in claims 1-20.

24. The computing device of claim 23, wherein the computing device is a host device.

25. The computing device of claim 23, wherein the computing device is a translation device comprising a first speaker element and a second speaker element.

26. The computing device of claim 23, wherein the computing device is a network-computing device.

27. A computing device, comprising means for performing any of the methods recited in claims 1-20.

28. The computing device of claim 27, wherein the computing device is a host device.

29. The computing device of claim 27, wherein the computing device is a translation device comprising a first speaker element and a second speaker element.

30. The computing device of claim 27, wherein the computing device is a network-computing device.

31. A system, comprising:
a memory configured to store processor-executable instructions; and
a processor in communication with the memory and configured to execute the processor-executable instructions to perform operations comprising any of the methods recited in claims 1-20.
